(19) United States
(12) Patent Application Publication
(10) Pub. No.: US 2006/0059531 A1
(43) Pub. Date: Mar. 16, 2006

(54) Information recording medium, information recording device and method, information reproduction device and method, information recording reproduction device and method, recording or reproduction control computer program, and data structure containing control signal

(76) Inventors: Yasuko Fukuda, Saitama (JP); Masanori Nakahara, Saitama (JP); Tohru Kanegae, Saitama (JP); Nobuyuki Takakuwa, Saitama (JP); Takao Sawabe, Saitama (JP); Takeshi Koda, Saitama (JP)

Correspondence Address: YOUNG & THOMPSON, 745 SOUTH 23RD STREET, 2ND FLOOR, ARLINGTON, VA, 22202, US

(21) Appl. No.: 10/508,410

(22) PCT Filed: Mar. 19, 2003
(86) PCT No.: PCT/JP03/03349

§ 371 Date: Jun. 13, 2005

(30) Foreign Application Priority Data
Mar. 22, 2002 (JP) 2002-80402

(51) Int. Cl. H04N 5/445; H04N 7/173; H04N 7/16; G06F 13/00; G06F 3/00

(52) U.S. Cl. 725/134; 725/52; 725/53; 725/142

(57) ABSTRACT

An information recording medium includes a file for storing object data consisting of a plurality of packets and further includes a file for storing correspondence definition information for controlling reproduction of the object data. The object data is interleaved in an angle block. The head of the interleaved unit has a navigation packet containing address information of the packets corresponding to each of the plurality of angles. The correspondence definition information includes information indicating a packet corresponding to each display start time and flag information indicating whether the packet is located at the position next to the navigation packet.

### TECHNICAL FIELD

The present invention relates to: an information recording medium, such as a high-density optical disc, on which various information can be recorded at high density, such as main picture information or video information, audio information, sub-picture information, and reproduction control information; an apparatus for and a method of recording the information onto the information recording medium; an apparatus for and a method of reproducing the information from the information recording medium; an apparatus and a method capable of both recording and reproducing the information and capable of editing contents, such as main pictures or video and audio, a computer program for controlling the record or the reproduction, and a data structure including a control signal for controlling the reproduction.

### BACKGROUND ART

DVDs are generalized as optical discs on which various information is recorded, such as content information, e.g. the video information, the audio information, and the sub-picture information, and the reproduction control information. According to the DVD standard, the video information (e.g. video data), the audio information (e.g. audio data), and the sub-picture information (e.g. sub-picture data) are individually packetized with the reproduction control information (e.g. navigation data) and are multiplexed and recorded on a disc in the “program stream” format of the MPEG 2 (Moving Picture Experts Group phase 2) standard, which is a highly efficient encoding technique. In the video information among them, there is only one stream of data compressed according to the MPEG video format (ISO 13818-2) within one program stream. On the other hand, the audio information is recorded in a plurality of methods (namely, linear PCM, AC-3, MPEG audio, and the like). The audio information can exist up to 8 streams within one program stream. The sub-picture information is defined with a bit map and is compressed and recorded in a run-length method. The sub-picture information can exist up to 32 streams within one program stream. In the case of the DVD, as described above, a plurality of streams of the chooseable or selectable audio information (e.g. streams of a stereo sound, a surrounding sound, an original English sound, a dubbed Japanese sound, and the like) and a plurality of streams of the chooseable or selectable sub-picture information (e.g. streams of Japanese subtitle, English subtitle, and the like) are multiplexed and recorded by using the program stream format, for one stream of the video information in one movie or film, for example.

In this DVD type, furthermore, it is possible to achieve an “angle reproduction” in which a plurality of video information relating to an image or scene from a plurality of viewpoints (hereinafter referred to as an “angle”, as appropriate) is recorded onto a same disc, and a user select a desired angle to be reproduced. Thereby, according to the DVD, the plurality of video information corresponding to each angle are interleaved with each other, by an interleaved unit (ILVU). A navigation packet (NV_PCK) disposed at a head of a video object unit (VOBU) consisting of each interleaved unit stores therein angle size information (SML_AGLI) indicating an address and size of the interleaved unit to be nextly reproduced for each angle.

### DISCLOSURE OF INVENTION

In the above-described DVD, an address map (VTS_VOBU_ADMAPI) storing therein address information for the video object unit (VOBU) is used to access the video information. Therefore, even if a reproduction entry is in the interleaved block, the head of the interleaved unit is always accessed to reproduce the navigation packet, and then the video information in the interleaved unit is reproduced.

However, in a large storage capacity and high record density optical disc under development by the present applicant, a time map (referred to as ES address information in the present embodiment) storing therein a packet number corresponding to each display start time point is used to access the video information. Therefore, if the reproduction entry is in the interleaved block, an access is made to a “half way point” within the interleaved unit. As the result, the video information is reproduced without reproducing the navigation packet, and the interleaved unit to be nextly reproduced cannot be identified, which is a technical problem.

It is therefore an object of the present invention to provide an information recording medium, an apparatus for and a method of recording information, an apparatus for and a method of reproducing the information, an apparatus for and a method of recording and reproducing the information, a computer program for controlling the record or the reproduction, and a data structure including a control signal for controlling the reproduction, which make it possible to reproduce the navigation packet disposed at the head of the interleaved block, without increasing the address information.

The above object of the present invention can be achieved by an information recording medium on which content information including a plurality of video information is multiplexed-and-recorded, comprising: an object data file, which is a logically accessible unit, for storing object data which comprises a plurality of packets, each storing therein a piece of the content information; a reproduction sequence information file for storing reproduction sequence information which defines a reproduction sequence of the object data stored in said object data file; and an object information file for storing correspondence definition information to control the reproduction of said object data, wherein said object data is interleaved by a unit of an interleaved unit consisting of a plurality of packets in at least part of a reproduction range, a navigation packet for storing address information of the next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is the packet positioned next to the navigation packet.

According to the information recording medium of the present invention, the object data file, which is a logically accessible unit, for storing object data which comprises a plurality of packets, each storing therein a piece of the content information. The contents information may include audio information (e.g. sound in a movie) and/or sub-picture information (e.g. caption in a movie), in addition to the plurality of video information. Furthermore, the plurality of video information may be video information different for angles corresponding to a plurality of view points, as mentioned later, or may be a plurality of video information having or not-having a specific relationship with each other, except for the video information different for angles. In any case, the plurality of video information is adapted to be switched during the reproduction. The reproduction sequence information stores reproduction sequence information (e.g. playlist information) to define a reproduction sequence of the object data stored in the object data file. The object information file stores the correspondence definition information (e.g. an ES map table mentioned below) including information indicating a packet corresponding to each display start time point, for each of the plurality of video information.

Especially, the object data is divided into a plurality of interleaved unit which are interleaved in at least part of a reproduction range (e.g. an angle block mentioned below). In other words, a plurality of interleaved unit is disposed alternately.

A length of the interleaved unit (data volume) is to be equal to the order of a reproduction time period from a few-tenth of 1 second to a few seconds. It has a length so as not to empty a buffer for the seamless reproduction during a jump between reproduction positions in making the angle reproduction for example by the information reproducing apparatus. The length of the interleaved unit can vary depending on the contents of the contents information (e.g. motion level in a motion picture indicated by the video information). However, the length may be fixed.

Furthermore, at a head of the interleaved unit which is interleaved as mentioned above, the navigation packet is disposed. The navigation packet stores address information of the next interleaved unit corresponding to each of the plurality of video information. Furthermore, the correspondence definition information stores flag information indicating whether a packet corresponding to each display start time point is a packet positioned next to the navigation packet.

Therefore, on starting the reproduction (including the fast-forwarding/fast-rewinding), the address information of the next packet can be firstly obtained on the basis of the flag information, and an address of the navigation packet can be identified on the basis of the obtained address information. Thus, referring to correspondence definition information on starting the reproduction makes it possible to make an access to the navigation packet. Thereby, then reading out the address information stored in the navigation packet and making an access to the interleaved unit corresponding to the after-switched video information on the basis of the address information make it possible to complete the access for a shorter time period and start the reproduction quickly. Furthermore, even in the case of the reproduction involving a plurality of switching such as an angle switching as mentioned below, it is possible to make an access to the appropriate interleaved unit without difficulty.

Thus, it is not necessary to incorporate the address information for all the packets into the correspondence definition information, nor to add the address information for each packet to each packet itself (e.g. packet header). Incidentally, if there is no flag information according to the present invention, it is basically difficult to perform the switching quickly, because an address information table indicating the address information for the navigation packet is required to be generated and this generated table is firstly required to be referred to on starting the reproduction.

Therefore, reproducing the contents information for a relatively short time period via the buffer for the seamless reproduction makes also it possible to perform readily the seamless reproduction (e.g. a seamless angle reproduction) by which the reproduced video image has no seam. Furthermore, interleaving makes it possible to perform the seamless and high-quality reproduction, while the data volume of each video information is maintained relatively large (e.g. a few Mbps for each video information). In order to shorten a response time period for the switching in the seamless reproduction, the above described length of the interleaved unit may be set shorter, preferably in practice 1.5 seconds or shorter for example.

Incidentally, various information to be stored into the object information file and the reproduction sequence information file according to the present invention is nor preferably multiplexed by unit of the packet, different from the case of the object data file. Therefore, it is possible to reproduce the object data in the information reproducing apparatus, on the basis of these reproduction control information and the reproduction sequence information. Furthermore, the address of the packet as referred herein may be a physical address, but more generally, it may be a logical address. The actual physical address has a characteristic of being specified uniquely from the logical address by the management of the file system.

In one aspect of the information recording medium of the present invention, if the video information is based on a MPEG (Moving Picture Experts Group phase) standard, the packet corresponding to said each display start time point corresponds to an “I” picture, the flag information indicates whether or not the packet is the packet corresponding to the “I” picture positioned next to the navigation packet.

According to this aspect, when reproducing, firstly referring to the information indicating the packet included in the correspondence definition information makes it possible to identify the “I” picture, and thereby reproduce the “I” picture on the basis of the display start time point Furthermore, on the basis of the “I” picture, a “B” picture and a “P” picture can be reproduced, and audio information can be reproduced, if the audio information exists corresponding to the video information. Especially, on the basis of the flag information, the navigation packet can be identified, and on the basis of the address information stored therein, the after-switched interleaved unit can be identified, and the identified unit can be reproduced after switched. In this case, it is possible to reduce the information volume to be recorded onto the information recording medium as a whole, by including no address information of the “B” picture or “P” picture, and/or no address information of the packet corresponding to the audio information into the correspondence definition information.

Incidentally, in the interleaved unit, usually a plurality of “I” picture packets exist, and the navigation packet does not always exist in front of each “I” picture.

In another aspect of the information recording medium of the present invention, the address information of the next interleaved unit is indicated by a packet number starting from a head of an interleaved block consisting of the interleaved interleave units which are interleaved.

According to this aspect, when reproducing, the address of the next interleaved unit can be identified on the basis of the packet number (a serial number of packets) starting from the head of the interleaved block. For example, counting the packet number makes it possible to identify the address of any interleaved unit disposed in the interleaved block.

In another aspect of the information recording medium of the present invention, the navigation packet further stores unit size information for indicating a size of the next interleaved unit.

In this arrangement, on the basis of the length of the interleaved unit obtained by referring to the unit size information, a position of the interleaved unit to be successively reproduced and apart from the interleaved unit whose length is obtained with a distance of a few interleaved units can be readily identified. Therefore, it is possible to reproduce relatively easily the interleaved units existing discretely with unspecified length intervals.

In another aspect of the information recording medium of the present invention, the correspondence definition information further has table information for indicating, for each of the plurality of video information, a packet identification number assigned uniquely to a plurality of packets to be multiplexed on a time axis.

According to this aspect, it is possible to identify readily which packet from among the plurality of packets, which may be multiplexed for example at the same time on the reproduction time axis, corresponds to which view point on the basis of a packet identification number (e.g. an ES_PID (elementary stream packet ID) mentioned later). The packet identification number is assigned uniquely to the plurality of packets to be multiplexed on the time axis and is indicated for each of the plurality of video information (e.g. for each angle) in the table information included in the correspondence definition information (e.g. the ES map table information mentioned later).

In another aspect of the information recording medium of the present invention, the plurality of video information corresponds to a plurality of an angle video information corresponding to a plurality of view points, the object data is interleaved so that a reproduction start time point and a reproduction end time point of the interleaved unit as for the plurality of angle video information correspond to each other.

According to this aspect, the plurality of video information corresponding to the plurality of viewpoints, i.e. the contents information including the video information different for angles in the angle reproduction is multiplexed and recorded by the packet unit. A part of the contents information consisting of the video information different for angles is hereinafter referred to as an “angle block”. On the other hand, other than the angle block, the contents information including the video information corresponding to one usual viewpoint is multiplexed and recorded by the packet unit.

Since interleaving is performed so that the reproduction start time point and the reproduction end time point in the interleaved unit correspond to each other over a plurality of angles, reading out the address information of the interleaved unit stored in the navigation packet when the information reproducing apparatus performs the angle switching, and making an access to the packet corresponding to the video information after the angle switching on the basis of the read address information make it possible to perform the switching for a shorter time period. Therefore, reproducing the contents information for a relatively short time period via the buffer for the seamless reproduction makes it possible to perform readily the seamless angle reproduction.

The angle blocks may be disposed at a plurality of positions apart from each other on the reproduction time axis in one title (e.g. movie). In this case, the angle quantity may be the same or different in the same title or over the different titles. The audio information and the sub-picture information after the angle switching may be the same disregarding of the video information (main video information) switching, or may be switched in response to the video information switching.

The “angle switching” herein includes a case that the after-switched video information is reproduced from a position reversed by a predetermined time period in the after-switched video information, in addition to a case that the switching is performed between two or more video information at the same time point on the reproduction time axis.

Furthermore, in this aspect of the angle, the address information of the next interleaved unit stored in the navigation packet may be the packet number (a serial number of packets) in the angle block. That is, if there is a plurality of angle blocks, a serial number independent in each angle block starts from a reference value such as “0” or “1”. Therefore, even if an editing is performed out of the angle block and thereby a packet serial number in the object data file is changed, a packet serial number on the address information stored in the navigation packet in the angle block is maintained. That is, it is possible not to change the packet serial number relating to the navigation packet and/or the involved address information, which is convenient. Incidentally, since the angle block has a complicated data structure in which the plurality of video information switchable to each other is interleaved, the editing inside of this structure is typically difficult.

In another aspect of the information recording medium of the present invention, the navigation packet further stores (i) angle number information for indicating a number of an angle relating to the interleaved unit in which the navigation packet is disposed and (ii) angle quantity information for indicating a quantity of switchable angles.

According to this aspect, referring to the navigation packet by the information reproducing apparatus makes it possible to identify the angle number and/or the angle quantity relating to the interleaved unit under the reproduction, and to perform various controls in the angle reproduction quickly and readily.

Additionally, in the aspect of the angle, the reproduction sequence information file may be arranged to further store angle quantity information for indicating a quantity of the switchable video information for each angle block. In this arrangement, in addition to reading the object data file storing the object data under the reproduction, referring to the reproduction sequence information file before or after this reading by the information reproducing apparatus makes it possible to identify the total quantity of angles in each angle block and perform various controls in the angle reproduction quickly and readily.

Furthermore, in an aspect of the angle, the reproduction sequence information file may be arranged to further store the predetermined angle number information for indicating a default video information from among the plurality of video information, for each angle block. In this arrangement, in addition to reading out the object data file storing the object data under the reproduction, referring to the reproduction sequence information file before or after this reading by the information reproducing apparatus makes it possible to control the angle as a default in each angle block, taking account of the contents maker's intent. Furthermore, changing this default can be readily achieved by re-writing the predetermined angle number in the reproduction sequence information. Incidentally, during the actual reproduction by the information reproducing apparatus, it goes without saying that the default angle is switched to another angle in response to the user's angle switching operation such as a key entry or the like.

The above object of the present invention can be achieved by an information recording apparatus for multiplexing and recording content information including a plurality of video information onto an information recording medium, said information recording apparatus comprising: a first recording device for recording an object data file, which is a logically accessible unit, for storing object data which comprises a plurality of packets, each storing therein a piece of the content information; a second recording device for recording a reproduction sequence information file for storing reproduction sequence information which defines a reproduction sequence of the object data stored in said object data file; and a third recording device for recording an object information file for storing correspondence definition information to control the reproduction of said object data, wherein said object data is interleaved by a unit of an interleaved unit consisting of a plurality of packets in at least part of a reproduction range, a navigation packet for storing address information of the next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is the packet positioned next to the navigation packet.

According to the information recording apparatus of the present invention, the object data file for storing the object data is recorded by the first recording device, such as a system controller, an encoder, a TS object generator as described later, and an optical pickup, or the like. The reproduction sequence information file for storing the reproduction sequence information is recorded by the second recording device, such as a system controller, an encoder, a TS object generator as described later, and an optical pickup, or the like. The object information file for storing the correspondence definition information to control the reproduction of the object data is recorded by the third recording device, such as a system controller, an encoder, a TS object generator as described later, and an optical pickup, or the like. Furthermore, the object data is interleaved. The navigation packet is disposed at each head of the plurality of interleaved unit. Furthermore, the correspondence definition includes the information indicating the packet corresponding to each display start time point and the flag information indicating whether or not the packet is a packet positioned next to the navigation packet. Therefore, it is possible to multiplex and record, while interleaving reproducibly, the plurality of video information, such as at least one portion of the transport stream of the MPEG 2, for example, onto the above-described information recording medium of the present invention.

Incidentally, the information recording apparatus of the present invention can also take various aspects in response to various aspects of the above-described information recording medium of the present invention.

The above object of the present invention can be achieved by an information recording method of multiplexing and recording content information including a plurality of video information onto an information recording medium, said information recording method comprising: a first recording process of recording an object data file, which is a logically accessible unit, for storing object data which comprises a plurality of packets, each storing therein a piece of the content information; a second recording process of recording a reproduction sequence information file for storing reproduction sequence information which defines a reproduction sequence of the object data stored in said object data file; and a third recording process of recording an object information file for storing correspondence definition information to control the reproduction of said object data, wherein said object data is interleaved by a unit of an interleaved unit consisting of a plurality of packets in at least part of a reproduction range, a navigation packet for storing address information of the next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is the packet positioned next to the navigation packet.

According to the information recording method of the present invention, the object data file for storing the object data is recorded at the first recording process. The reproduction sequence information file for storing the reproduction sequence information is recorded at the second recording process. The object information file for storing the correspondence definition information to control the reproduction of the object file is recorded at the third recording process. Furthermore, the object data is interleaved. The navigation packet is disposed at each head of the plurality of interleaved unit. Furthermore, the correspondence definition includes the information indicating the packet corresponding to each display start time point and the flag information indicating whether or not the packet is a packet positioned next to the navigation packet. Therefore, it is possible to multiplex and record, while interleaving reproducibly, the plurality of video information, such as at least one portion of the transport stream of the MPEG 2, for example, onto the above-described information recording medium of the present invention.

Incidentally, the information recording method of the present invention can also take various aspects in response to various aspects of the above-described information recording medium of the present invention.

The above object of the present invention can be achieved by an information reproducing apparatus for reproducing the recorded content information from said information recording medium mentioned above (including its various aspects), said information reproducing apparatus comprising: a reading device for physically reading information from said information recording medium; and a reproducing device for reproducing the object data included in the information read by said reading device on the basis of the correspondence definition information and the reproduction sequence information included in the information read by said reading device, and for reproducing the plurality of video information respectively on the basis of the address information stored in the navigation packet included in the information read by said reading device.

According to the information reproducing apparatus of the present invention, information is physically read by the reading device, such as an optical pickup and a demodulator or the like, from the information recording medium by a unit of packet or the like. Then, the object data included in the read information is reproduced by the reproducing device, such as a system controller, a demultiplexer, and a decoder, or the like, on the basis of the correspondence definition information and the reproduction sequence information included in this read information. In this case, furthermore, the plurality of interleaved video information can be reproduced, on the basis of the address information stored in the navigation packet included in the read information.

Incidentally, the information reproducing apparatus of the present invention can also take various aspects in response to various aspects of the above-described information recording medium of the present invention.

The above object of the present invention can be achieved by an information reproducing method of reproducing the recorded content information from said information recording medium mentioned above (including its various aspects), said information reproducing method comprising: a reading process of physically reading information from said information recording medium; and a reproducing process of reproducing the object data included in the information read at said reading process on the basis of the correspondence definition information and the reproduction sequence information included in the information read at said reading process, and of reproducing the plurality of video information respectively on the basis of the address information stored in the navigation packet included in the information read at said reading process.

According to the information reproducing method of the present invention, information is physically read at the reading process from the information recording medium by a unit of packet or the like. Then, the object data included in the read information is reproduced at the reproducing process on the basis of the correspondence definition information and the reproduction sequence information included in this read information. In this case, furthermore, the plurality of interleaved video information can be reproduced, on the basis of the address information stored in the navigation packet included in the read information.

Incidentally, the information reproducing method of the present invention can also take various aspects in response to various aspects of the above-described information recording medium of the present invention.

The above object of the present invention can be achieved by an information recording and reproducing apparatus for recording content information onto said information recording medium mentioned above (including its various aspects) and reproducing the recorded content information, said information recording and reproducing apparatus comprising: a first recording device for recording the object data file; a second recording device for recording the reproduction sequence information file; a third recording device for recording the object information file; a reading device for physically reading information from said information recording medium; and a reproducing device for reproducing the object data included in the information read by said reading device on the basis of the correspondence definition information and the reproduction sequence information included in the information read by said reading device, and for reproducing the plurality of video information respectively on the basis of the address information stored in the navigation packet included in the information read by said reading device.

According to the information recording and reproducing apparatus of the present invention, as with the above-described information recording apparatus of the present invention, the object data file is multiplexed and recorded by the first recording apparatus. The reproduction sequence information file is recorded by the second recording device. The object information file is recorded by the third recording device. Then, as with the above-described information reproducing apparatus of the present invention, information is physically read by the reading device from the information recording medium. Then, the object data included in the read information is reproduced by the reproducing device on the basis of the correspondence definition information and the reproduction sequence information included in this read information. In this case, furthermore, the plurality of interleaved video information can be reproduced, on the basis of the address information stored in the navigation packet included in the read information. Therefore, it is possible to multiplex and record appropriately the plurality of video information, such as at least one portion of the transport stream of the MPEG 2, onto the above-described information recording medium of the present invention, and further it is possible to appropriately reproduce the plurality of multiplexed and recorded video information.

Incidentally, the information recording and reproducing apparatus of the present invention can also take various aspects in response to various aspects of the above-described information recording medium of the present invention.

The above object of the present invention can be achieved by an information recording and reproducing method of recording content information onto said information recording medium mentioned above (including its various aspects) and reproducing the recorded content information, said information recording and reproducing method comprising: a first recording process of recording the object data file; a second recording process of recording the reproduction sequence information file; a third recording process of recording the object information file; a reading process of physically reading information from said information recording medium; and a reproducing process of reproducing the object data included in the information read at said reading process on the basis of the correspondence definition information and the reproduction sequence information included in the information read at said reading process, and of reproducing the plurality of video information respectively on the basis of the address information stored in the navigation packet included in the information read at said reading process.

According to the information recording and reproducing method of the present invention, as with the above-described information recording method of the present invention, the object data file is multiplexed and recorded at the first recording process. The reproduction sequence information file is recorded at the second recording process. The object information file is recorded at the third recording process. Then, as with the above-described information reproducing method of the present invention, information is physically read at the reading process from the information recording medium. Then, the object data included in the read information is reproduced at the reproducing process on the basis of the correspondence definition information and the reproduction sequence information included in this read information. In this case, furthermore, the plurality of interleaved video information can be reproduced, on the basis of the address information stored in the navigation packet included in the read information. Therefore, it is possible to multiplex and record appropriately the plurality of video information onto the above-described information recording medium of the present invention, and further it is possible to appropriately reproduce the plurality of multiplexed and recorded video information.

Incidentally, the information recording and reproducing method of the present invention can also take various aspects in response to various aspects of the above-described information recording medium of the present invention.

The above object of the present invention can be achieved by a computer program for controlling record which controls a computer provided in the above-described information recording apparatus of the present invention (including its various aspects) and which causes the computer to function as at least one portion of the first recording device, the second recording device, and the third recording device.

According to the computer program for controlling record of the present invention, the above described information recording apparatus of the present invention can be relatively easily realized as a computer reads and executes the computer program from a program storage device, such as a ROM, a CD-ROM, a DVD-ROM, and a hard disk, or the like, or as it executes the computer program after downloading the program through a communication device.

The above object of the present invention can be achieved by a computer program for controlling reproduction which controls a computer provided in the above-described information reproducing apparatus of the present invention (including its various aspects) and which causes the computer to function as at least one portion of the reproducing device.

According to the computer program for controlling reproduction of the present invention, the above described information reproducing apparatus of the present invention can be relatively easily realized as a computer reads and executes the computer program from a program storage device, such as a ROM, a CD-ROM, a DVD-ROM, and a hard disk, or the like, or as it executes the computer program after downloading the program through a communication device.

The above object of the present invention can be achieved by a computer program for controlling record and reproduction which controls a computer provided in the above-described information recording and reproducing apparatus of the present invention (including its various aspects) and which causes the computer to function as at least one portion of the first recording device, the second recording device, the third recording device, and the reproducing device.

According to the computer program for controlling record and reproduction of the present invention, the above described information recording and reproducing apparatus of the present invention can be relatively easily realized as a computer reads and executes the computer program from a program storage device, such as a ROM, a CD-ROM, a DVD-ROM, and a hard disk, or the like or as it executes the computer program after downloading the program through a communication device.

The above object of the present invention can be achieved by a data structure including a control signal, in which content information including a plurality of video information is multiplexed-and-recorded, having: an object data file, which is a logically accessible unit, for storing object data which comprises a plurality of packets, each storing therein a piece of the content information; a reproduction sequence information file for storing reproduction sequence information which defines a reproduction sequence of the object data stored in said object data file; and an object information file for storing correspondence definition information to control the reproduction of said object data, wherein said object data is interleaved by a unit of an interleaved unit consisting of a plurality of packets in at least part of a reproduction range, a navigation packet for storing address information of the next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is the packet positioned next to the navigation packet.

According to the data structure including a control signal of the present invention, as with the case of the above described information recording medium of the present invention, it is possible to record and reproduce efficiently the plurality of interleaved video information by the information reproducing apparatus. Therefore, it is possible to perform the angle reproduction seamlessly and readily. Furthermore, since a relative large data volume of each video information can be maintained by interleaving, it is possible to perform the seamless and high-quality angle reproduction.

The above object of the present invention can be also achieved by a first program storage device readable by a computer in an information recording apparatus for tangibly embodying a program of instructions executable by the computer to perform the above-described information recording method of the present invention.

The above object of the present invention can be also achieved by a second program storage device readable by a computer in an information reproducing apparatus for tangibly embodying a program of instructions executable by the computer to perform the above-described information reproducing method of the present invention.

The above object of the present invention can be also achieved by a third program storage device readable by a computer in an information recording and reproducing apparatus for tangibly embodying a program of instructions executable by the computer to perform the above-described information recording and reproducing method of the present invention.

According to the first, second, or third program storage device, such as a CD-ROM, a ROM, a DVD-ROM, and a hard disk, or the like, of the present invention, the above described information recording method, information reproducing method, or information recording and reproducing method of the present invention can be relatively easily realized as a computer reads and executes the program of instructions or as it executes the program after downloading the program through a communication device.

The above object of the present invention can be also achieved by a first computer data signal embodied in a carrier wave and representing a series of instructions which cause a computer in an information recording apparatus to perform the above-described information recording method of the present invention.

The above object of the present invention can be also achieved by a second computer data signal embodied in a carrier wave and representing a series of instructions which cause a computer in an information reproducing apparatus to perform the above-described information reproducing method of the present invention.

The above object of the present invention can be also achieved by a third computer data signal embodied in a carrier wave and representing a series of instructions which cause a computer in an information recording and reproducing apparatus to perform the above-described information recording and reproducing method of the present invention.

According to the first, second, or third computer data signal embodied in the carrier wave of the present invention, as the computer downloads the program in the computer data signal through a computer network or the like, and executes this program, it is possible to relatively easily realize the above described information recording method, information reproducing method, or information recording and reproducing method of the present invention.

These functions and other advantages of the present invention will be apparent from the following description of embodiments.

### BRIEF DESCRIPTION OF DRAWINGS

FIG. 1 is a diagram showing a basic structure of an optical disc as being one embodiment of an information recording medium of the present invention, the upper part being a schematic plan view of the optical disc having a plurality of areas, the corresponding bottom part being a schematic diagram of the area structure in the radial direction;

FIG. 2 are a schematic diagram of the conventional program stream of the MPEG 2 (FIG. 2(a)) and a schematic diagram of the transport stream of the MPEG 2 used in the embodiment (FIG. 2(b));

FIG. 3 is a schematic diagram showing a data structure recorded on the optical disc in the embodiment;

FIG. 4 is a schematic diagram showing details of the data structure in each object shown in FIG. 3;

FIG. 5 is a schematic diagram showing that an elementary stream for a program #1 at an upper level and an elementary stream for a program #2 at a middle level are multiplexed, constituting a transport stream for these two programs at a low level, with the horizontal axis as a time axis;

FIG. 6 is a schematic diagram showing the image of TS packets multiplexed in one transport stream as a packet alignment along time;

FIG. 7 is a schematic diagram showing the logical construction of data on the optical disc in the embodiment, focusing on the development of a logical hierarchy to an object hierarchy or an entity hierarchy;

FIG. 8 is a conceptual diagram showing the data structure of the TS object including the angle block and the usual block according to the embodiment, along with the time axis;

FIG. 9 is a conceptual diagram showing a specific example of the data structure of the TS object according to the embodiment;

FIG. 10 is a schematic diagram showing the data structure in the case that the TS object is made of one program in the specific example;

FIG. 11 is a schematic diagram showing the data structure in the case that the TS object is made of three programs in the specific example;

FIG. 12 is a schematic diagram showing the data structure of the TS object finally constructed on the optical disc in the specific example;

FIG. 13 is a schematic diagram showing one specific example of the data structure of the disc information file, in one specific example of the embodiment;

FIG. 14 is a schematic diagram showing one specific example of the data structure of the title information table included in the disc information file, in one specific example of the embodiment;

FIG. 15 is a schematic diagram showing one specific example of the data structure of a play list information table constructed in a play list information file in one specific example of the embodiment;

FIG. 16 is a schematic diagram showing one specific example of the data structures of an AU table constructed in an object information file and an ES map table related to the AU table in one specific example of the embodiment;

FIG. 17 is a characteristic diagram showing one example of the relationship between the bit rate for each angle and the upper limit rate on the time axis, in the statistical multiplexing system used in the embodiment;

FIG. 18 is a schematic diagram showing the data structure of the interleaved block used in the embodiment;

FIG. 19 is a schematic diagram showing the angle switching in the interleaved block used in the embodiment;

FIG. 20 is a conceptual diagram schematically showing the data structure of the navi packet in the embodiment;

FIG. 21 is a conceptual diagram showing a specific example of FIG. 20;

FIG. 22 is a conceptual diagram schematically showing the meaning of the address information indicating the angle switching jump destination stored in the navi packet in the embodiment;

FIG. 23 is a conceptual diagram showing the data structure of the angle block of title #1;

FIG. 24 is a conceptual diagram showing a specific example of the ES address information in the video stream in each angle of title #1 in the embodiment;

FIG. 25 is a conceptual diagram showing a reproduction principle using interleaving and the navigation packet in the embodiment;

FIG. 26 is a conceptual diagram showing another reproduction principle using interleaving and the navigation packet in the embodiment;

FIG. 27 is a conceptual diagram showing another reproduction principle using interleaving and the navigation packet in the embodiment;

FIG. 28 is a conceptual diagram showing another reproduction principle using interleaving and the navigation packet in the embodiment;

FIG. 29 is a block diagram showing an information recording/reproducing apparatus related to the embodiment of the present invention;

FIG. 30 is a flow chart showing a record operation (part 1) of the information recording/reproducing apparatus in the embodiment;

FIG. 31 is a flow chart showing a record operation (part 2) of the information recording/reproducing apparatus in the embodiment;

FIG. 32 is a flow chart showing a record operation (part 3) of the information recording/reproducing apparatus in the embodiment.

FIG. 33 is a flow chart showing a record operation (part 4) of the information recording/reproducing apparatus in the embodiment;

FIG. 34 is a flow chart showing a reproduction operation of the information recording/reproducing apparatus in the embodiment;

FIG. 35 is a flow chart showing a packet number obtaining process in FIG. 34;

FIG. 36 is a flow chart showing a navi packet obtaining process in FIG. 34;

FIG. 37 is a flow chart showing a non-seamless process in FIG. 34;

FIG. 38 is a flow chart showing a FW/BW process in FIG. 34; and

FIG. 39 is a conceptual diagram showing a general flow of an access in the reproduction, focusing on the relationship with the logical construction of the optical disc.

### BEST MODE FOR CARRYING OUT THE INVENTION

(Information Recording Medium)

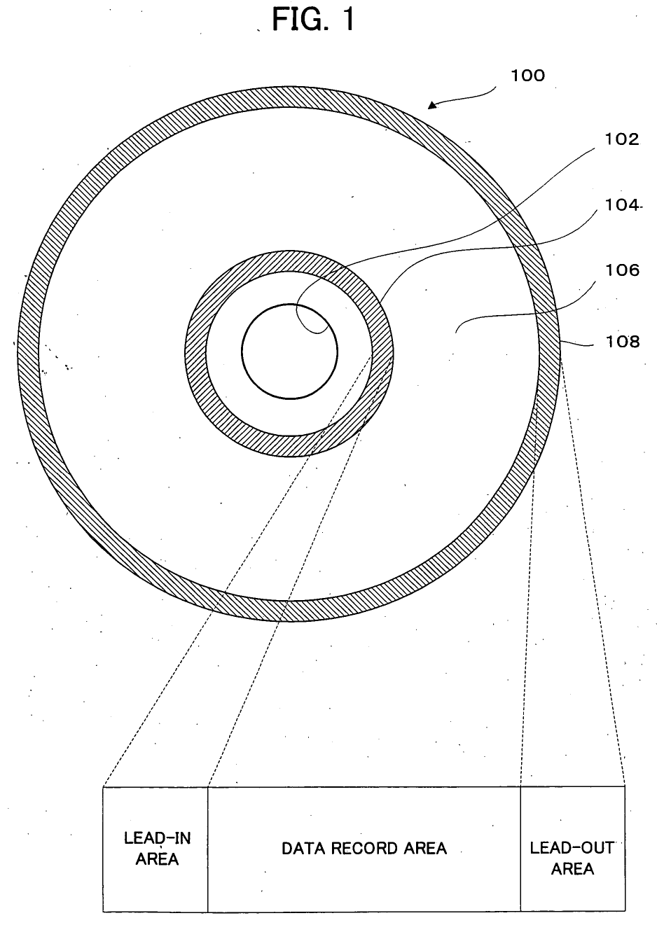

The embodiment of an information recording medium of the present invention will be explained with reference to FIG. 1 to FIG. 7. In this embodiment, the information recording medium of the present invention is applied to an optical disc of a type capable of recording (writing) and reproducing (reading).

Firstly, the basic structure of the optical disc in the embodiment will be explained with reference to FIG. 1. The upper part of FIG. 1 is a schematic plan view of the optical disc structure having a plurality of areas, and the bottom part is a schematic diagram of the area structure in its radial direction As shown in FIG. 1, an optical disc 100 is recordable in various recoding methods, such as a magnet-optical method and a phase transition method, onto which it is possible to record (write) information a plurality of times or only once. It is provided with a lead-in area 104, a data record area 106, and a lead-out area 108 on a recording surface on the disc main body, which is about 12 cm in diameter, as is the DVD, with a center hole 102 as the center, in the direction from the inner circumference to the outer circumference. In each area, groove tracks and land tracks are alternately placed spirally or coaxially with the center hole 102 as the center, for example. These groove tracks may be wobbled, and pre-pits may be formed on either or both of the tracks. Incidentally, the present invention is not specially limited to an optical disc having these three areas.

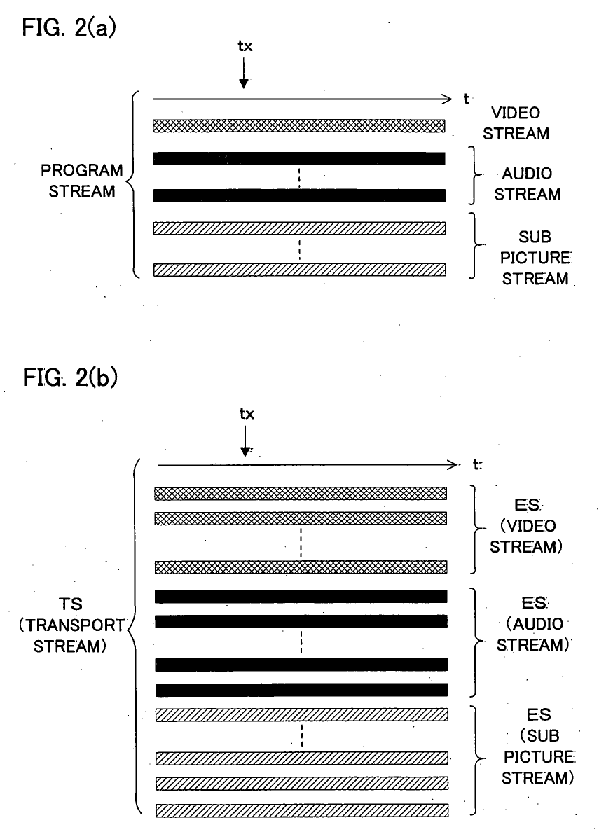

Secondly, the structure of a transport stream (TS) recorded on the optical disc of the present invention will be explained with reference to FIG. 2. FIG. 2(a) schematically shows the structure of a conventional program stream of the MPEG 2 in the conventional DVD, as a comparison. FIG. 2(b) schematically shows the structure of the transport stream (TS) of the MPEG 2.

In FIG. 2(a), one program stream includes (i) only one video stream for video data as being the video information, and further (ii) at most 8 audio streams for audio data as being the audio information, and also (iii) at most 32 sub-picture streams for sub-picture data as being the sub-picture information, along a time axis t. Namely, the video data multiplexed at an arbitrary time point tx is related to only the one video stream. For example, a plurality of video streams corresponding to a plurality of TV shows or movies cannot be included in the program stream at the same time. In order to multiplex the TV show and the like accompanying pictures and transmit or record them, at least one video stream is required for each TV show and the like, so that the program stream format in which only one video stream exists cannot allow the plurality of TV shows and the like to be transmitted or recorded after multiplexing them.

In FIG. 2(b), one transport stream (TS) includes (i) a plurality of video streams, as an elementary stream (ES) for the video data as being the video information, and further (ii) a plurality of audio streams, as an elementary stream (ES) for the audio data as being the audio information, and also (iii) a plurality of sub-picture streams, as an elementary stream (ES) for the sub-picture data as being the sub-picture information. Namely, the video data multiplexed at an arbitrary time point tx is related to the plurality of video streams. For example, the plurality of video streams corresponding to a plurality of TV shows or movies can be included in the transport stream at the same time. As described above, the transport stream format whose transmission rate is high and in which there are the plurality of video streams can allow the plurality of TV shows and the like to be transmitted or recorded after multiplexing them. However, digital broadcasting that employs an existing transport stream does not transmit the sub-picture stream.

Incidentally, in FIG. 2(a) and FIG. 2(b), the video stream, the audio stream, and the sub-picture stream are arranged in this order from up to down for explanatory convenience; however, this order is not intended to correspond to an order of multiplexing them by a unit of packet, as described later, or the like. In the transport stream, one combination, which is one video stream, two audio streams, and two sub-picture streams, conceptually corresponds to one show, for example.

The optical disc 100 in the embodiment described above is constructed to multiplex-and-record onto it the transport stream (TS) including a plurality of elementary streams (ES) in the above manner, to simultaneously record onto it the plurality of shows or programs.

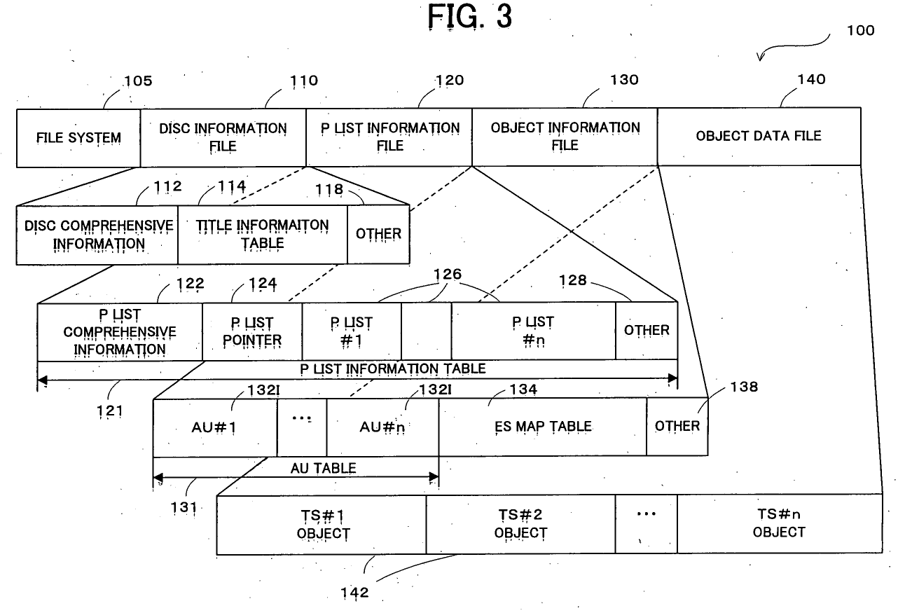

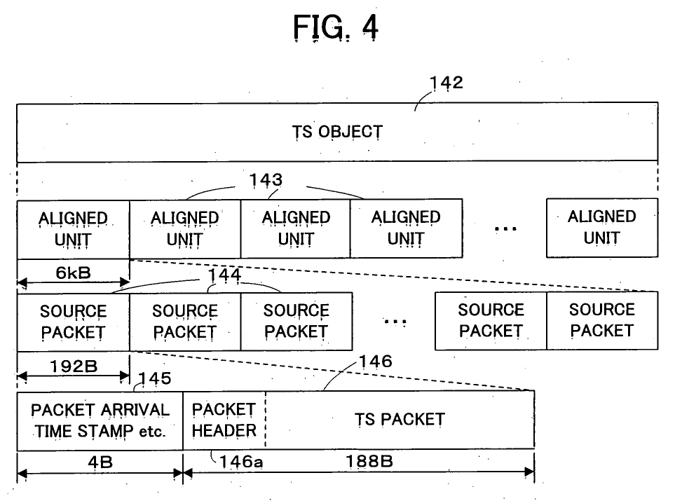

Next, a data structure recorded on the optical disc 100 will be explained with reference to FIG. 3 and FIG. 4. FIG. 3 schematically shows the data structure recorded on the optical disc 100. FIG. 4 schematically shows details of the data structure in each object shown in FIG. 3.

In the explanation below, a “title” is a reproduction unit sequentially executing a plurality of “play lists”, and is a logically large grouped unit, such as one movie and one TV show. The “play list” is a file for storing information necessary for the reproduction of an “object”, and is provided with a plurality of “Items”, each of which stores information about the reproduction range of the object to access the object. More specifically, “IN point information” indicating a start address of the object and “OUT point information” indicating an end address of the object are written in each Item. Incidentally, these “IN point information” and “OUT point information” may show the addresses directly, or show the addresses indirectly by showing a time length or a time point on a reproduction time axis. The “object” is the entity information of a content constituting the transport stream of the MPEG 2 described above.

In FIG. 3, the optical disc 100 is provided with the following four files as a logical structure: a disc information file 110, a play (P) list information file 120, an object information file 130, and an object data file 140. It is further provided with a file system 105 to manage those files. Incidentally, FIG. 3 does not directly show the physical data alignment on the optical disc 100, but it is possible to record with the arrangement order shown in FIG. 3 corresponding to the arrangement order shown in FIG. 1. Namely, it is possible to record the file system 105 or the like in the lead-in area 104, and then in the data record area 106, and further it is also possible to record the object data file 140 or the like in the data record area 106. Even if the lead-in area 104 and/or the lead-out area 108 shown in FIG. 1 do no exist, the file structure shown in FIG. 3 can be constructed.

The disc information file 110 is a file for storing comprehensive information about the whole optical disc 100, and it stores disc comprehensive information 112, a title information table 114, and other information 118. The disc comprehensive information 112 stores the total quantity of titles and the like in the optical disc 100, for example. The title information table 114 stores, for each title, each title type (e.g. a sequential reproduction type, a branch type, and the like) and a play (P) list number, which constitutes each title, as logical information.

The play list information file 120 stores a play (P) list information table 121, which indicates the logical construction of each play list and which is separated into play (P) list comprehensive information 122, a play (P) list pointer 124, a plurality of play (P) lists 126 (P lists #1 to #n), and other information 128. This play list information table 121 stores the logical information of each play list 126 in the order of the play list number. In other words, the storing order of each play list 126 is the play list number. Moreover, it is also possible to refer to the same play list 126 from a plurality of titles at the above described title information table 114. Namely, even in the case where a title #n and a title #m use the same play list #p, it is possible to construct such that the play list #p in the play list information table 121 is pointed at the title information table 114.

The object information file 130 stores various attribute information about the storing position in the object data file 140 for each Item constituted in each play list 126 (i.e. a logical address that is a reproduction object) and about the reproduction of the Item. Especially, in this embodiment, the object information file 130 stores an AU (Associate Unit) table 131 including a plurality of AU information 132I (AU #1 to AU #n), as described later in detail, an ES (Elementary Stream) map table 134, and other information 138.

The object data file 140 stores a plurality of TS objects 142 (TS #1 object to TS #n object) for each transport streams (TS). Namely, it stores a plurality of entity data of the contents to be actually reproduced.

Incidentally, the four files explained with reference to FIG. 3 may be stored with each of them being separated into a plurality of files, and all of them may be managed or administered by the file system 105. For example, the object data file 140 can be separated into a plurality of data files, such as an object data file #1, an object data file #2, . . . and the like.

As shown in FIG. 4, the TS object 142 shown in FIG. 3, which is a logically reproducible unit, is divided into a plurality of aligned units 143, each of which has 6 kB data amount, for example. The head of the aligned units 143 corresponds to (or is “aligned” with) the head of the TS object 142. Each aligned unit 143 is further segmentized into a plurality of source packets 144, each of which has 192 B data amount. The source packet 144 is a physically reproducible unit, and by using this unit, i.e. by a unit of packet, at least the video data, the audio data, and the sub-picture data are multiplexed among the data on the optical disc 100. The other information may be also multiplexed in this manner. Each source packet 144 includes: control information 145, which has 4 B data amount, for controlling the reproduction, such as a packet arrival time stamp indicating a reproduction start time point of the TS (transport stream) packet on a reproduction time axis etc.; and a TS packet 146, which has 188B data amount. The TS packet 146 has a packet header 146a at the head portion thereof. The video data is packetized to be a “video packet”, the audio data is packetized to be an “audio packet”, the sub-picture data is packetized to be a “sub-picture packet”, or the other data is packetized.

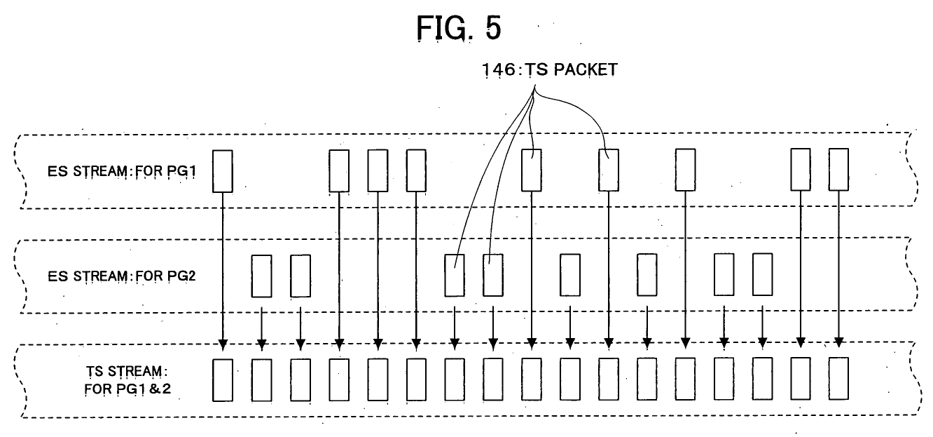

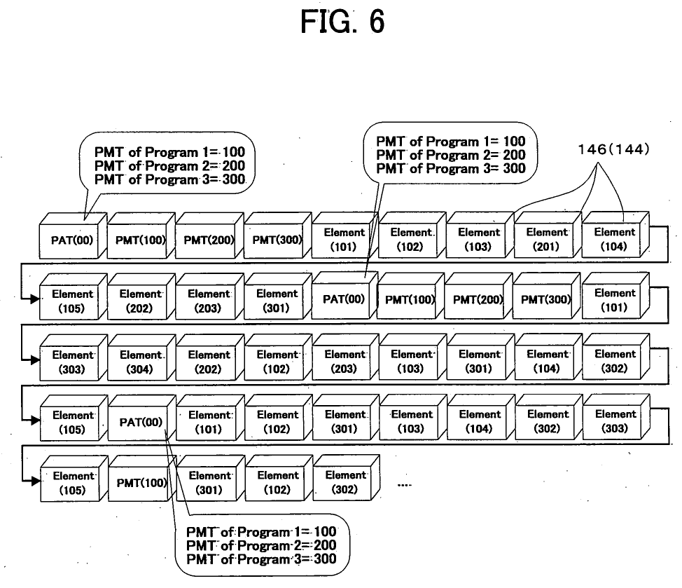

Next, with reference to FIG. 5 and FIG. 6, it will be explained the multiple record of the video data, the audio data, the sub-picture data, and the like, which are in the transport stream format as shown in FIG. 2(b), on the optical disc 100 by the TS packet 146 shown in FIG. 4. FIG. 5 schematically shows that an elementary stream (ES) for a program #1 (PG 1) at the upper level in the figure and an elementary stream (ES) for a program #2 (PG 2) at the middle level in the figure are multiplexed, constituting a transport stream (TS) for these two programs (PG 1 & PG 2) at the lower level in the figure, with the horizontal axis as a time axis. FIG. 6 schematically shows the image of TS packets multiplexed in one transport stream (TS) as a packet alignment along time.

As shown in FIG. 5, the TS packets 146 with the video data for the program #1 packetized are discretely arranged with respect to the time axis in the elementary stream for the program #1 (the upper one), for example. The TS packets 146 with the video data for the program #2 packetized are discretely arranged with respect to the time axis in the elementary stream for the program #2 (the middle one), for example. Then, these TS packets 146 are multiplexed, constructing the transport stream (the lower one) for those two programs. Incidentally, this is omitted in FIG. 5 for explanatory convenience, but in fact, the elementary stream provided with the TS packets in which the audio data is packetized and the sub-picture stream provided with the TS packets in which the sub-picture data is packetized may be multiplexed as the elementary stream for the program #1 in the same manner as shown in FIG. 2(b). Moreover, in addition to these, the elementary stream provided with the TS packets in which the audio data is packetized and the sub-picture stream provided with the TS packets in which the sub-picture data is packetized may be multiplexed as the elementary stream for the program #2 in the same manner.

As shown in FIG. 6, in this embodiment, one TS stream is constructed of many TS packets 146 multiplexed as described above. Then, the many TS packets 146 in this multiplexed form obtain the information 145 such as the packet arrival time stamp and are multiplexed-and-recorded on the optical disc 100. Incidentally, “Element (i0j)” is used in FIG. 6 for the TS packet 146 comprising data which constitutes the program #i (i=1, 2, 3), with j (j=1, 2, . . . ) as a number indicating the order for each stream which constitutes the program. This (i0j) is a packet ID, which is the identification number of the TS packet 146 for each elementary stream. A specific value is given to this packet ID between the plurality of TS packets 146 multiplexed at the same time point so that the plurality of TS packets 146 can be mutually distinguished even if they are multiplexed at the same time point.

In FIG. 6, a PAT (Program Associate Table) and a PMT (Program Map Table) are also packetized by a unit of the TS packet 146 and are multiplexed. Among them, the PAT stores a table indicating a plurality of PMT packet IDs. Especially, with regard to the PAT, the MPEG 2 standard defines the addition of (000), as shown in FIG. 6, as a predetermined packet ID. Namely, it is constructed such that the TS packet 146 in which the PAT is packetized is detected as the TS packet 146 with its packet ID (000) from among many packets multiplexed at the same time point. The PMT stores a table indicating the packet ID for each elementary stream constituting each program with respect to one or a plurality of programs. To the PMT, an arbitrary packet ID may be added, but the packet ID of the PMT is indicated by the PAT detectable having the packet ID as (000), as described above. Therefore, the TS packets 146 in each of which the PMT is packetized (i.e. the TS packets 146 with the packet IDs (100), (200), and (300) added in FIG. 6) are detected by virtue of the PAT from among many packets multiplexed at the same time point.

In the case where the transport stream is digital-transmitted as shown in FIG. 6, the tuner can pick up the packets corresponding to the desired elementary stream from among the multiplexed packets by referring to the PAT and the PMT as constructed above, and demodulate them.

In this embodiment, the TS packet 146 stored in the TS object 142 shown in FIG. 4 includes these PAT and PMT packets. Namely, when the transport stream shown in FIG. 6 is transmitted, it can be recorded onto the optical disc 100 as it is, which is a great advantage.

Moreover, in this embodiment, the PAT and PMT as recorded above are not referred to when reproducing the optical disc 100. Instead, referring to the AU table 131 and the ES map table 134, as shown in FIG. 3 and as described later in detail, allows more effective reproduction, and also enables complicate multi-vision reproduction and the like to be treated with. On that account, in this embodiment, the corresponding relationship between the elementary stream and the packet, which are obtained by referring to the PAT and the PMT when demodulating and recording, is stored in the object information file 130 in the form of the AU table 131 and the ES map table 134 without packetizing nor multiplexing.

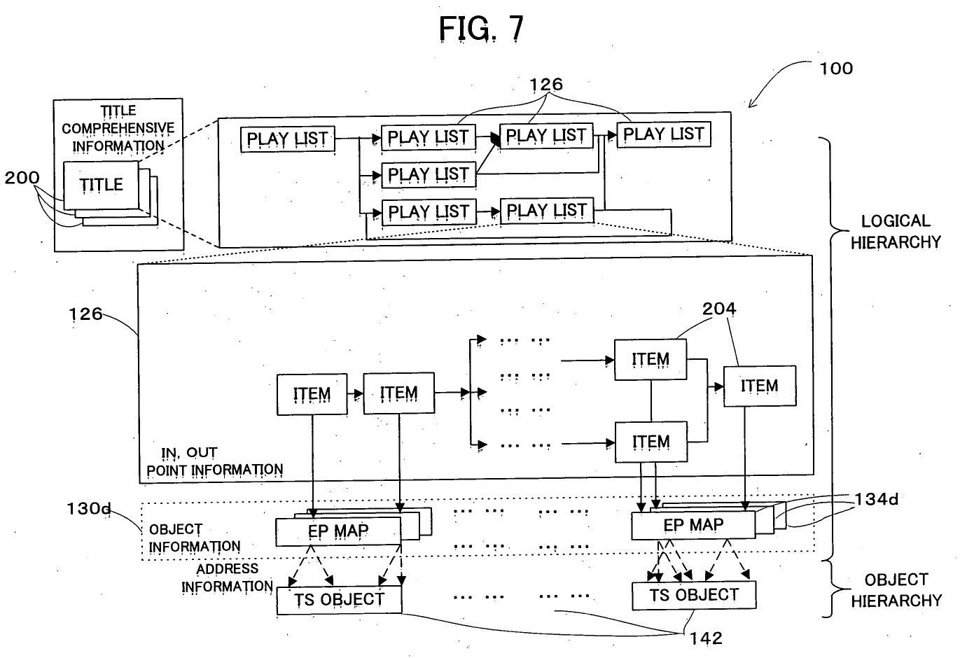

Next, the logical construction of the data on the optical disc 100 will be explained with reference to FIG. 7. FIG. 7 schematically shows the logical construction of the data on the optical disc 100, focusing on the development of a logical hierarchy to an object hierarchy or an entity hierarchy.

In FIG. 7, the optical disc 100 records one or a plurality of titles 200, each of which is a logically large unit, such as one movie or one TV show. Each title 200 is logically constructed of one or a plurality of play lists 126. In each title 200, the plurality of play lists 126 may have a sequential structure or a branch structure Incidentally, in the case of a simple logical construction, one title 200 is constructed of one play list 126. Moreover, one play list 126 can be referred to from the plurality of titles 200.

Each play list 126 is logically constructed of a plurality of Items (i.e., the play items) 204. In each play list 126, the plurality of Items 204 may have the sequential structure or the branch structure. Moreover, one Item 204 can be referred to from the plurality of play lists 126. The reproduction range of the TS object 142 is logically specified by the above described IN point information and OUT point information written in the Item 204. Then, by referring to object information 130d with respect to the reproduction range logically specified, the reproduction range of the TS object 142 is physically specified via the file system in the end. Here, the object information 130d includes various information to reproduce the TS object 142, such as the attribute information of the TS object 142 and ES address information 134d required for a data search in the TS object 142 (incidentally, the ES map table 134 shown in FIG. 3 includes a plurality of such ES address information 134d).

When reproducing the TS object 142 by an information recording/reproducing apparatus, which will be described later, a physical address to be reproduced in the TS object 142 is obtained from the Item 204 and the object information 130d, and the desired elementary stream is reproduced.

In this embodiment, as described above, the association from the logical hierarchy to the object hierarchy of the reproduction sequence is made by the IN point information and the OUT point information described in the Item 204 and by the ES address information 134d described in the ES map table 134 (refer to FIG. 3) of the object information 130d, which enables the elementary stream to be reproduced.

Especially in this embodiment, the navigation packet including control information for a seamless angle reproduction as mentioned below is also multiplexed, as one kind of the TS packet 146 (or the source packet 144) shown in FIG. 4 to FIG. 6, with the video packet, the audio packet, and the sub-picture packet. These packets are interleaved with each other by the interleaved unit as mentioned below. The corresponding navigation packet is disposed at the head of each interleaved unit, and other video packets and so on, as the entity information, are disposed at positions other than the head of each of the interleaved unit. Namely, an arrangement of the TS packet 146 (source packet 144) in the transport stream as shown in FIG. 5 and FIG. 6 is interleaved by the interleaved unit in which a plurality of packets, usually variable in their quantity, is united. Then interleaved arrangement is recorded onto the optical disc 100.

Incidentally, in FIG. 5 and FIG. 6, the source packet 144 is obtained by adding a packet arrival time stamp or the like 145 to the TS packet 146 (see FIG. 4). Therefore, the source packet 144 and the TS packet 146 are not required to be distinguished in view of an sequence or arrangement of packets to be multiplexed, the interleave and so on.

In such a data construction, at least one of the title 200 shown in FIG. 7 has a reproduction period (hereinafter referred to as an “angle block”, as appropriate) during which images or scenes from a plurality of viewpoints, i.e. the plurality of video information relating to the plurality of angle, are reproduced, in addition to a reproduction period (hereinafter referred to as a “usual block”, as appropriate) during which the video information relating to an image or scene from a single viewpoints (i.e. only a single angle) is reproduced. In this embodiment, the “angle reproduction” is possible, so that the user switches seamlessly the plurality of angles in this angle block. The interleaved structure and the navigation packet (or the like) structure allowing such a seamless angle switching will be mentioned below in detail.

(Specific Example of Data Structure Relating to Angle Block)

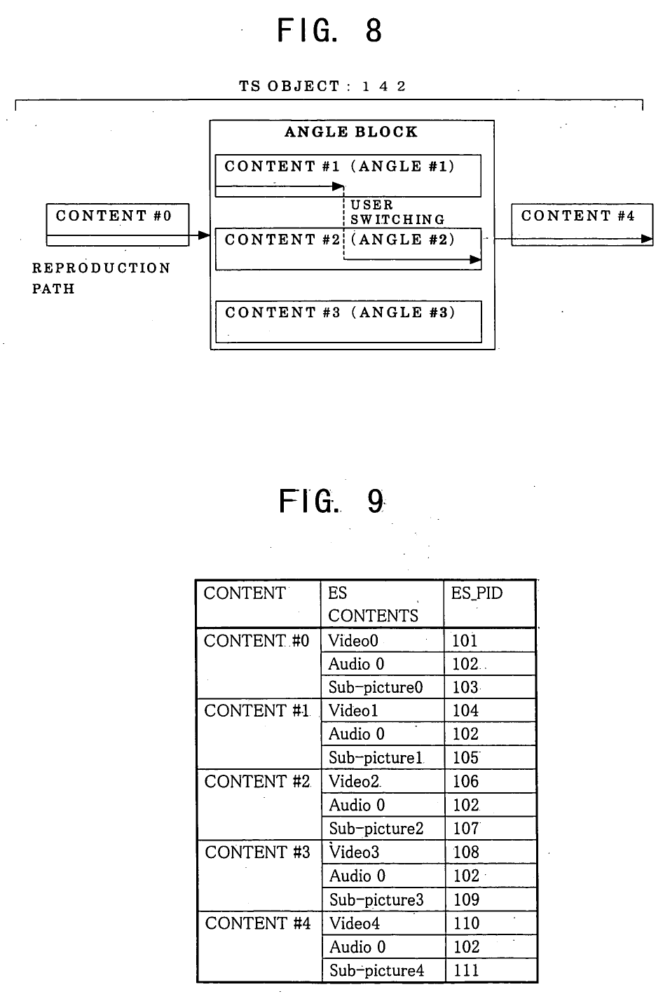

Next, with reference to FIG. 8 to FIG. 12, a data structure of the TS object 142 relating to the angle block for the angle reproduction in this embodiment will be explained in accordance with the specific example.

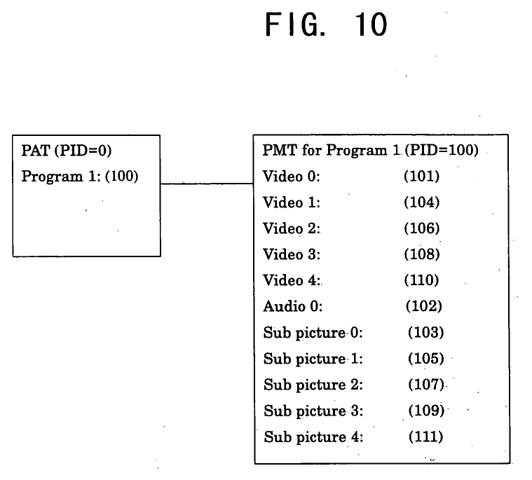

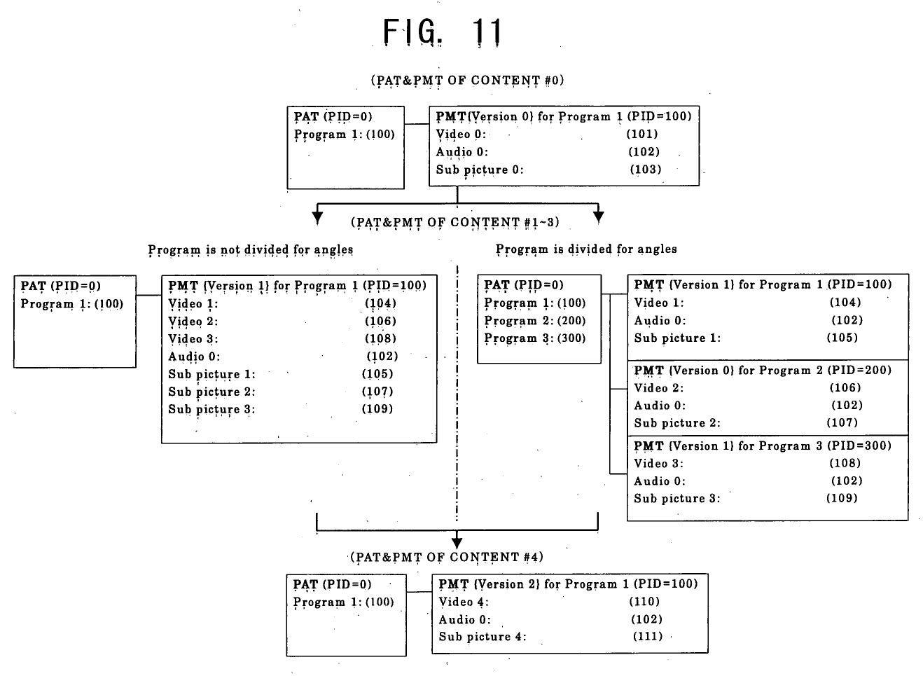

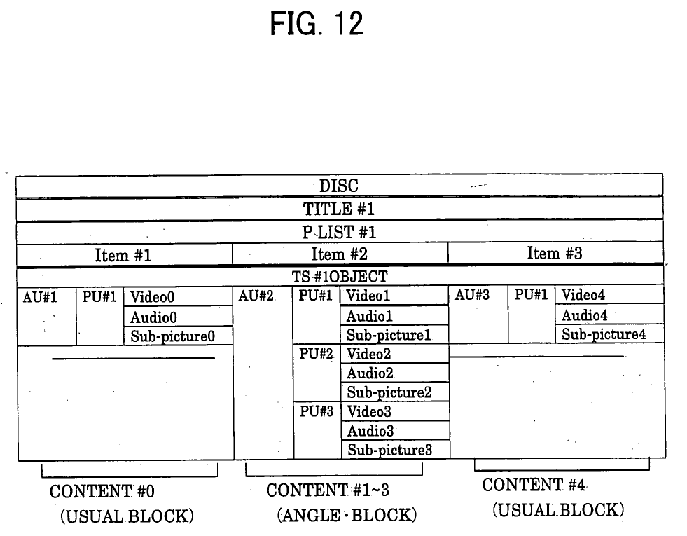

This specific example is a specific example of the data structure relating to the angle block constructed on the optical disc 100, in the case that the TS object 142 consists of five contents #0-#4, the usual block consists of the contents #0 and #4, and the angle block consists of the contents #1-#3 sandwiched by the content #0 and the content #4. Herein, FIG. 8 illustrates conceptually the data structure of the TS object including the angle block and the usual block, along a time axis. FIG. 9 illustrates conceptually the data structure of the TS object. FIG. 10 illustrates schematically the data structure in the case that the TS object consists of one program in this specific example. FIG. 11 illustrates schematically the data structure in the case that the TS object consists of three programs. Furthermore, FIG. 12 schematically the data structure of the TS object finally constructed on the optical disc 100 in this specific example.

As shown in FIG. 8, the TS object 142 is subjected to an authoring to be stored as a ROM content, and has three angles selectable by the user during the reproduction, with a common audio elementary stream and a common sub-picture elementary stream for these three angles.

Since the content #0 positions within the usual block, it is impossible to perform the angle reproduction during the reproduction of the content #0. The content #0 is reproduced usually and simply as shown by an arrow.

Within the angle block, the contents #1, #2 and #3 are subjected to the angle reproduction. This reproduction may be started from the head of the contents #1, #2 or #3 after the reproduction of the content #0 is end, or may be started from the head or from the half way point depending on a time search, a fast-forwarding, a fast-rewinding, or a branch condition and so on. In any case, within the angle block, it is possible for the user to perform the seamless angle switching, such as switching from the content #1 to the content #2 at any interleaved unit start time point as shown by an arrow.

Since the content #4 positions within the usual block, it is impossible to perform the angle reproduction during the reproduction of the content #4. The content #4 is reproduced simply and usually as shown by an arrow.

As shown in FIG. 9, each of five contents #0-#4, consisting of the TS object, is made of a video stream (Video 0-4), an audio stream (Audio 0), and a sub-picture stream (sub-picture 0-4). A packet ID (ES_PID) “101”, “102” etc. for each elementary stream as mentioned above is assigned to each stream.

The video stream of each content has a different packet ID from each other (i.e. “101”, “102”, . . . ). Especially in the angle block, the different video stream depending on the angle is reproduced, corresponding to switching the angle. That is, the angle reproduction is possible. Incidentally, it is also possible to assign the same packet ID (ES_PID) to the video streams of the contents #0 and #4 to use the same video stream for the contents #0 and #4. Furthermore, the video stream which is same as the video stream of the contents #0 and #4 may be used for either one of the contents #1 to #3 in the angle block.

The audio stream of each content has a common packet ID (i.e. “102”). With regard to the audio, this common stream is reproduced, regardless of the existence of the angle block. Especially in the angle block, the audio stream is not switched, even if the angle is switched. Namely, even if the angle is switched, the sound is not switched. However, it is possible to use a plurality of audio streams and switch the audio stream corresponding to switching the sound (i.e. the different sound may be reproduced), in the angle block.

The sub-picture stream of each content has a different packet ID for the contents #0-#4, so that the different elementary stream is reproduced. However, it is possible to use a common packet ID for the contents #0-#4 in the angle block.

With regard to the TS object 142 shown in FIGS. 8 and 9, two MPEG programs, as roughly classified, may be applicable.

That is, firstly, as shown in FIG. 10, there is a case that the TS object consists of a single program. In this case, on the transport stream as shown in FIG. 6, one PMT is identified by one PAT, and the packet IDs (ES_PIDs) for all the elementary streams relating to the contents #1-#3 are identified by this identified one PMT.

Alternatively, as shown in FIG. 11, there is a case that the TS object consists of three programs. Namely, three programs is divided into the usual block relating to the content #0, the angle block relating to the contents #1-#3, and the usual block relating to the content #4.

Furthermore, in the FIG. 11, there are two cases, i.e. a case that the program is not divided for each angle in the angle block, and a case that the program is divided for each angle in the angle block.

In the case that the program is not divided for each angle, in FIG. 11, as shown at the left side of the mid row, on the transport stream in the angle block, one PMT (ES_PID=100) is identified by the one PAT (ES_PID=000), and the packet IDs (ES_PID) for all the elementary streams relating to the contents #1-#3 are identified by this identified one PMT.

On the other hand, in the case that the program is divided for each angle, in FIG. 11, as shown at the right side of the mid row, on the transport stream in the angle block, a plurality of PMT (ES_PID=100, 200 and 300) are identified by one PAT (ES_PID=000), and the packet IDs (ES_PID) for all the elementary stream relating to the contents #0-#3 are identified by this identified PMTs.

As mentioned above, the data structure of the optical disc 100 explained with reference to FIGS. 8 to 11 are summarized as shown in FIG. 12.

That is, in FIG. 12, the optical disc 100 has a data structure in which a title #1 is constructed. The title #1 is made of a playlist #1 (P list #1) designating three items (Items #1-#3). Furthermore, one TS #1 object including the angle block is associated with the playlist #1 via three items. Especially, the title #1 which may relate to one “program” digitally broadcasted and recorded is logically constructed to be reproduced in the angle reproduction in the angle block.

Furthermore, with regard to the TS object in FIG. 12, a plurality of elementary stream constructing a set of contents, such as a video stream, an audio stream and a sub-picture stream which construct one movie for example is categorized by PU (presentation unit). Furthermore, a plurality of PUs forming sets switchable to each other by angle is categorized by AU (association unit). That is, switching an angle can be relatively readily performed by identifying an elementary stream from among elementary streams belonged to the different PUs in the same AU. Incidentally, information indicating which elementary stream belongs to which PU specifically, and which PU belongs to which AU is written within AU information 132I (see FIG. 3) in an AU table 131. The detail structure of the AU table will be explained later.

(Specific Example of Data Structure Relating to Each Information File)

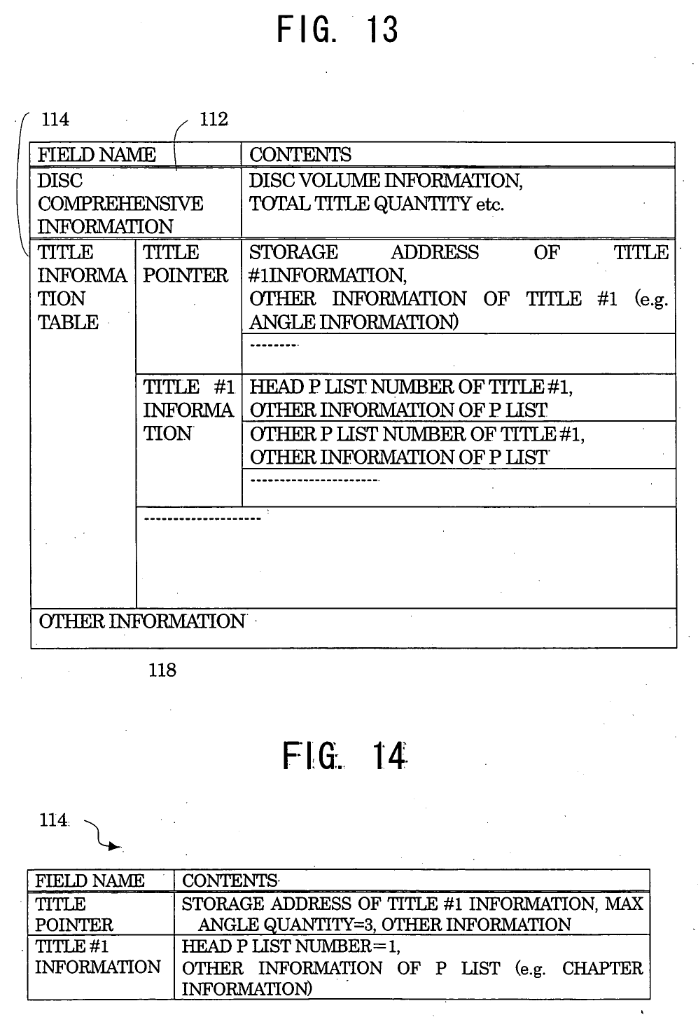

Next, with reference to FIGS. 13 to 18, various information files constructed on the optical disc 100 in this embodiment, i.e. (1) the disc information file 110, (2) the playlist information file 120 and (3) the object information file 130 which are explained with reference to FIG. 3 are explained with regard to their data structures, accompanying each specific example.

(1) Disc Information File

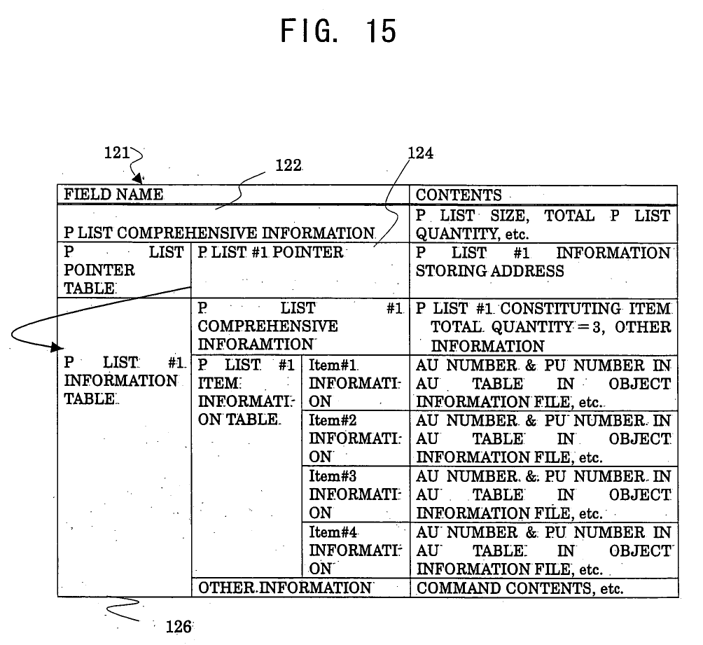

Firstly, with reference to FIGS. 13 and 14, the disc information file 110 is explained in detail with a specific example. FIG. 13 schematically illustrates a specific example of the data structure of the disc information file 110. FIG. 14 schematically illustrates a specific example of the data structure of a tile information table 114 included in the disc information file 110.

In this specific example as shown in FIG. 13, the disc information file 110 stores therein disc comprehensive information 112, the title information table 114 and other information 118.

The disc comprehensive information 112 is comprehensive disc information, such as disc volume information indicating serial numbers for a series of a plurality of optical discs 100, or such as total title quantity information and so on.

The title information table 114 stores therein all playlists consisting of each title, and other information such as chapter information within a title as information for each title. The title information table 114 includes title pointer information, title #1 information, title #2 information, etc. Here the “title pointer information” is storage address information of the title #n information, i.e. storage address information indicating a storage position of the title #n information in the title information table 114, the relationship between them shown by an arrow in FIG. 13. And the title pointer information is written by a relative logic address. The relative logic addresses corresponding to a quantity of titles in the optical disc 100 is listed in the order of titles. Incidentally, data volume of each storage address information may be a fixed byte or may be a variable byte.

In this embodiment, especially shown in FIG. 14, angle information relating to angles such as Max Angle quantity switchable during the angle reproduction of the title #n (#1 herein) is written in the title pointer, in addition to the storage address information. The Max Angle quantity may be set as “1” in the case of the usual reproduction other than the angle reproduction, for identifying the usual reproduction. The Max Angle quantity may be fixed in the same title, or may be variable in the same title (i.e. the switchable Max Angle quantity is different for each angle block).

Furthermore, other information 118 may be information about each title, such as title classification of the title (e.g. sequential type or branch type etc), or such as a number of a comprehensive playlist and so on.

(2) Playlist Information File

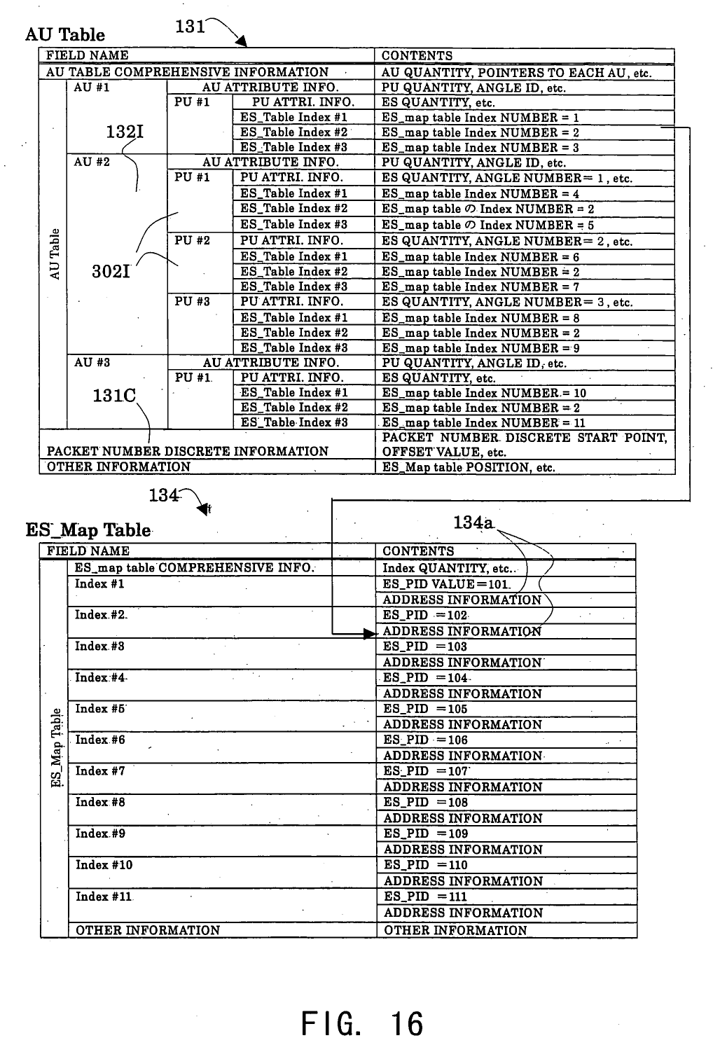

Next, with reference to FIG. 15, the playlist information file 120 is explained in detail, with a specific example. Here FIG. 15 schematically illustrates a specific example of the data structure of the playlist information table 121 constructed within the playlist information file 120.

As shown in FIG. 15, in this specific example, the playlist information file 120 stores therein, for each field, playlist comprehensive information 122, a playlist pointer table 124, and a playlist #1 information table 126 as the playlist information table 121 (see FIG. 3).

Each field may have a structure to add a required quantity of tables. For example, each field may have a structure in which the existence of four playlists increases a number of corresponding fields to four. The same discussion is applicable to the item information table.

Size of the playlist table and others, such as total playlist number and so on are written in the playlist comprehensive information (P list comprehensive information) 122.

The playlist pointer table (P list pointer table) 124 stores therein addresses of positions at which individual playlists are written, as shown by an arrow in FIG. 15, as relative logic addresses in the playlist information table 126.

The playlist #1 information table (P list #1 information table) 126 stores therein comprehensive information about the playlist #1, an item information table of the playlist #1 (P list Item information Table) and other information.

The “item information table” is for storing therein item information corresponding to all items consisting of one program list. Here an AU number in the AU (Associate unit) table to be written in the “item #n information”, wherein n=1, 2, 3, is a number of an AU storing therein information to identify each elementary stream (i.e. video stream, audio stream or sub-picture stream) in the TS object to be used for reproducing the item, or to identify an address of the TS object to be used for reproducing the item. Furthermore, the item information stores therein a PU number to be reproduced by default and belonged to this AU.

(3) Object Information File

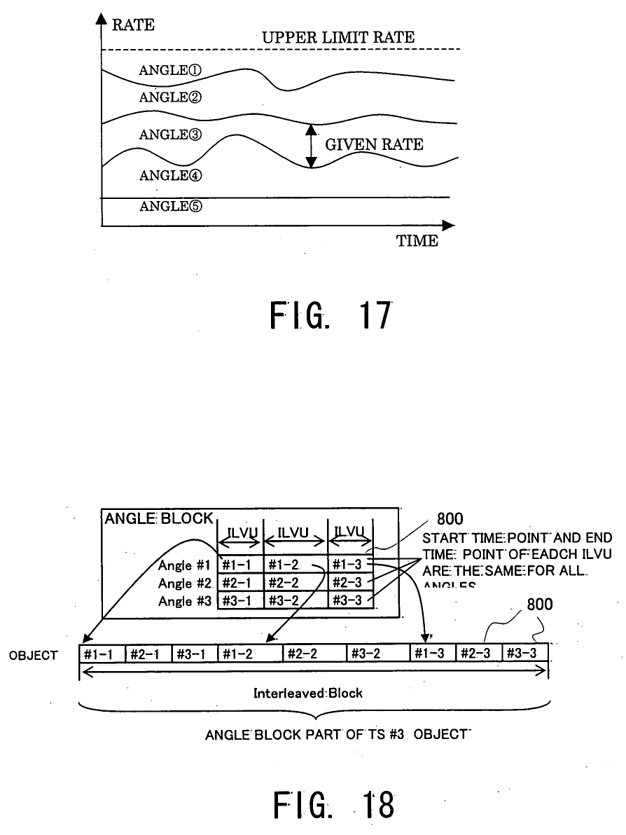

Next, with reference to FIG. 16, the object information file 130 is explained in detail, with a specific example. Here FIG. 16 schematically illustrates a specific example of the data structure of an AU (Associate Unit) table 131 (see FIG. 3) constructed within the object information file 130 and an ES map table 134 (see FIG. 3) associated with the AU table 131.

In this specific example as shown in FIG. 16, the object information file 130 stores therein an object information table. The object information table consists of an AU table 131 shown in the upper column in the figure and an ES map table 134 shown in the lower column in the figure.

In the upper column in FIG. 16, with regard to the AU table 131, each field may have a structure to add a required quantity of tables. For example, each field may have a structure in which the existence of four AUs increases a number of the corresponding fields.

The AU table 134 stores therein, in different fields, “AU comprehensive information” in which a quantity of AU, each pointer to each AU and so on are written, “packet number discretion information” and “other information”.

An index number of the corresponding ES map table 134 is written, as AU information 132I indicating an ES table index #1 (ES_table Index #1) in each PU #m corresponding to each AU #n, in the AU table 131. Here the “AU” is a unit corresponding to a program which may be reproduced in the angle reproduction as mentioned above. In this AU, one or more PUs as reproduction units are included. Furthermore, the “PU” is an assembly of elementary streams switchable to each other and included in each AU as mentioned above. An ES table index # corresponding to each PU is identified by the PU information 302I. For example, in the case that content which can be reproduced in the angle reproduction is constructed by an AU, a plurality of PUs are stored in the AU. And in each PU, pointers to a plurality of elementary stream packet IDs indicating packets constructing contents of each angle are stored. These pointers indicate index numbers in the ES map table 134, as mentioned below.

Especially in this embodiment, in the AU table 131, discrete information 131C indicating a discrete state of packet numbers, in a case that a packet defect arises in an editing process, is added to a serial numbers of packets in the TS object 142 mentioned above. Using discrete information makes it possible to identify an address of a packet to be accessed, by counting a quantity of a packet (starting from a packet designated in the elementary stream), in view of the discrete state indicated by the discrete information, without assigning a new packet number even in the case that the packet defect arises. The discrete information may include information indicating a discretion start point or a quantity of defected packets, for example. Thus, the discrete information 131C is described as only one information commonly for a plurality of AUs, which is very advantageous in view of saving the storage capacity.

Furthermore, in addition to the packet number, it is preferable to assign a serial numbers of packets in the interleaved block inherently to each interleaved block, as offset numbers from a head packet number set as “0”. Thereby, even in the case that an editing process such as a deletion out of the interleaved block, the aforementioned discrete information does not need to be referred in the interleaved block. Because, in the interleaved block of the angle, an access to the optical disc 100 is made by using the address information stored in the navi packet, excepting for fast-forwarding/fast-rewinding operation or non-seamless angle switching. However, in the case that the editing process such as the deletion in the interleaved block of the angle, individual reproduction time points of individual interleaved units 800 are required to be synchronized. For this, it is preferable to re-make contents and re-number the serial numbers (offset number) within a new interleaved block.

Especially in this embodiment, each AU information 132I includes AU attribute information indicating a total quantity of PU belonged to the AU, an angle identification to identify whether or not the AU is for the angle reproduction.

Furthermore, each PU information 302I includes PU attribute information indicating a quantity of an elementary stream. This PU attribute information also includes angle information indicating a quantity of an angle (e.g. 1, 2, 3, . . . ) corresponding to the PU, if the PU belongs to the AU for the angle reproduction. Furthermore, in this PU, pointers to the ES_PIDs consisting of contents of each angle are stored.

In the lower column of FIG. 16, in the ES map table 134, ES map table comprehensive information, a plurality of index # m (m=1, 2, . . . ) and “other information” are stored for each field.

In the “ES map table comprehensive information”, an ES map table size, a total quantity of the index and so on are described.

The “index #1” includes an elementary stream packet ID (ES_PID) of an elementary stream used for the reproduction and elementary stream address information.

Especially in this embodiment, as this address information, i.e. as ES address information 134a, the packet number (SPN) and the display start time corresponding to this are described. In the case that the elementary stream is a video stream of MPEG2 as mentioned above, only an address of the head TS packet of the I picture is described as the ES address information 134a in the ES map table 134, for reducing the data volume.

Owing to this construction, the elementary stream packet ID (ES_PID) of the actual elementary stream can be acquired on the basis of the index number of the ES map table 134 designated by the AU table 131. Furthermore, since the address information of the elementary stream corresponding to the elementary stream packet ID can be acquired at this occasion, object data can be reproduced on the basis of these information.

Incidentally, although not shown in FIG. 16, also the ES_PID which is not referred from the AU table 131 shown in the upper column may be described for each index of the ES map table 134 shown in the lower column. Thus, describing the not-referred ES_PID and thereby generating a more flexible ES map table 134 bring an advantage to eliminate a need to re-construct the ES map table in a case that contents are re-edited, such as re-authoring.

(Interleaved Structure and Navigation Packet)

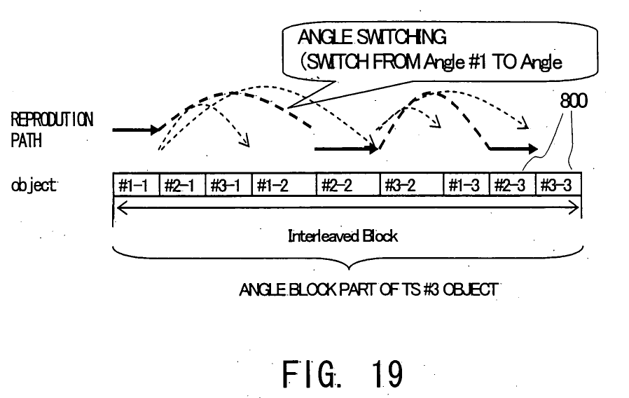

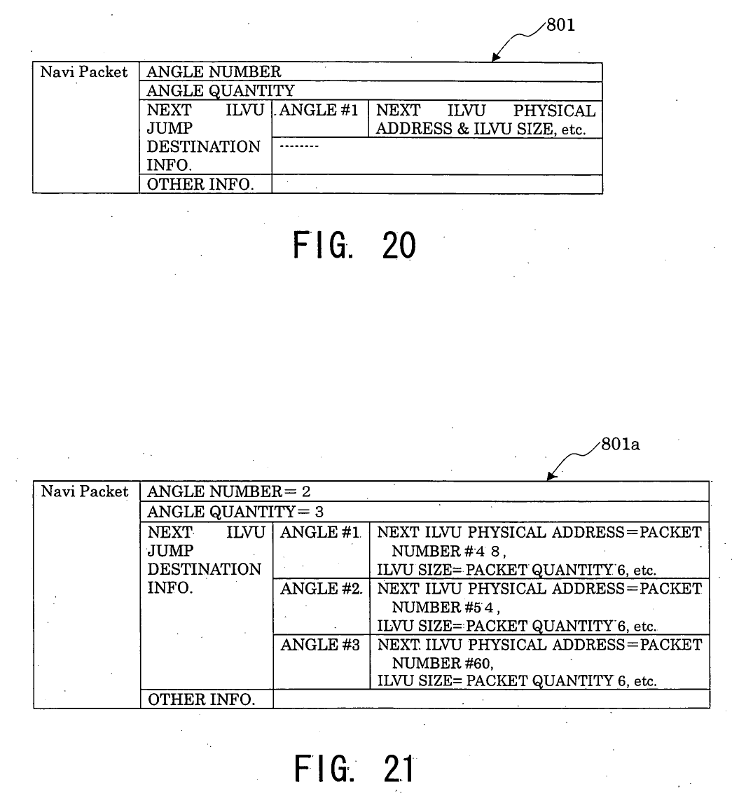

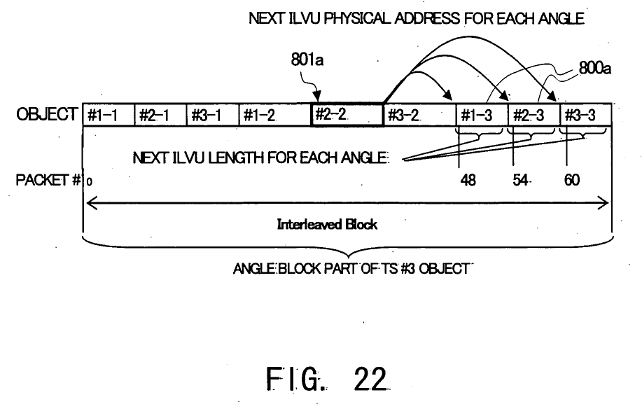

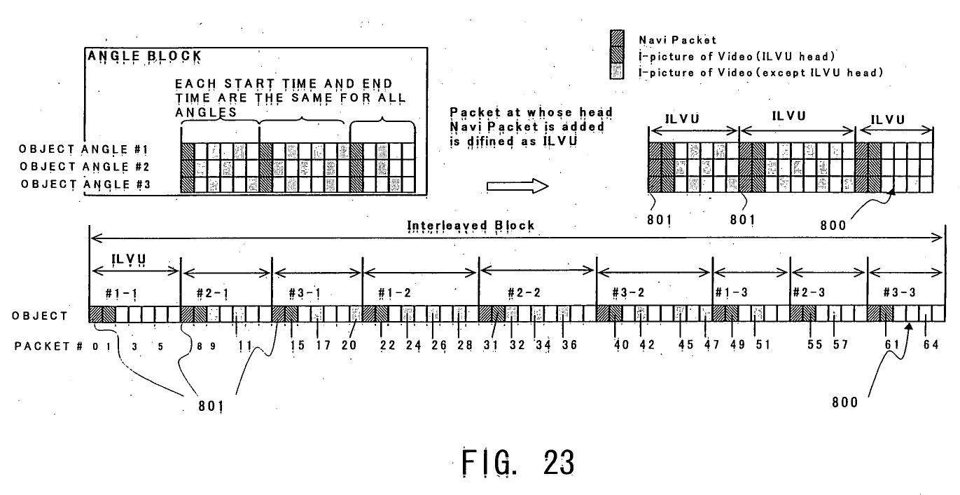

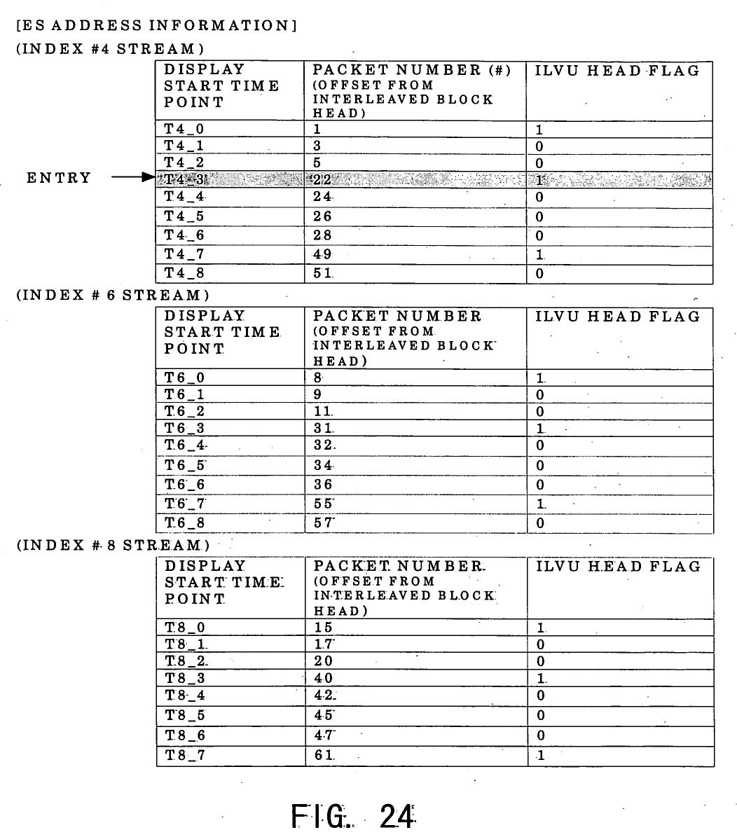

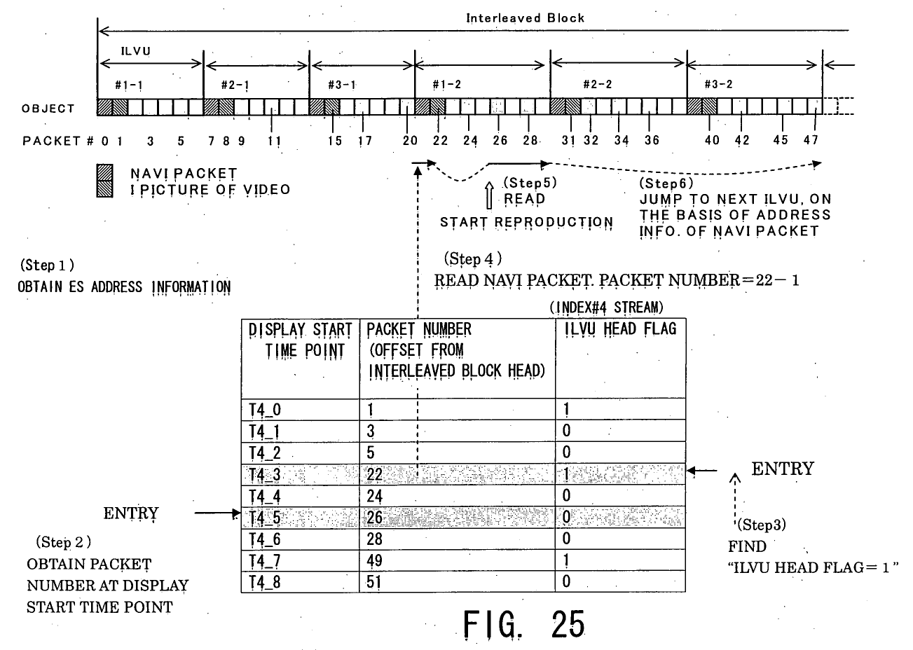

Next, an interleaved structure and a navigation packet in the TS object 142 mentioned above to perform the angle reproduction mentioned above quickly and seamlessly is explained, with reference to FIG. 17 to FIG. 28. FIG. 17 illustrates an exemplary relationship between a bit rate for each angle on a time axis and the upper limit rate, in a statistical multiplexing system used in this embodiment. FIG. 18 schematically illustrates a data structure of an interleaved block used in this embodiment. FIG. 19 schematically illustrates an angle switching in the interleaved block. FIG. 20 schematically illustrates a data structure of a navi packet, and FIG. 21 illustrates the specific example. FIG. 22 schematically illustrates meaning of the address information indicating an angle switching jump destination possessed by the navi pack. FIG. 23 conceptually illustrates a data structure of an angle block of title #1 in this embodiment. FIG. 24 illustrates a specific example of ES address information in a video stream of each angle of title #1 having such a structure. Furthermore, FIG. 25 to FIG. 28 conceptually illustrate a reproduction principle using the interleave and the navigation packet in this embodiment.

Incidentally, hereinafter, the navigation packet is referred to as “navi packet” for convenience.

As shown in FIG. 17, since the statistical multiplexing system is used in this embodiment, transfer rates for every elementary streams in a plurality of angles (angle #1-#5) may vary. That is, in FIG. 17, insofar as the sum does not excess the upper limit, the transfer rate that is indicated as a distance along the vertical axis can be assigned to each rate curve. Therefore, the transfer rate for a certain angle can be somewhat raised for a moment.

However, if a plurality of angle each of which has a high resolution of a HDTV level are simply multiplexed by the TS packet unit, the transfer rate may be lowered to a level adversely affecting the reproduction. For this reason, especially in this embodiment, the TS object 142 (see FIG. 4) has an interleaved structure by interleaved unit, in which the interleaved unit is defined an assembly of a usually variable plurality of TS packets 146 (or source packets 144).

Furthermore, as mentioned above, multiplexing the TS packet makes it possible to perform the angle reproduction by referring to the object information such as the AU table 131 (see FIG. 16 or the like).

However, if the object information is referred separately from the TS object 142 during the reproduction, for each angle switching, it is technically very difficult or even impossible to perform the switching quickly and seamlessly. For this reason, especially in this embodiment, the TS object 142 has a structure in which the navi packet in which the address information or the like about all the angles which may be reproduced after switching the angle is stored is disposed at the head position of each interleaved unit, for the seamless angle switching.

FIG. 18 conceptually illustrates a structure of “Interleaved Block” which is a part of the angle block mentioned above made of the plurality of interleaved unit.

In FIG. 18, the elementary stream corresponding to each angle (Angle #1-#3) consisting of an array of TS packets is divided into interleaved units (ILVU) 800 that is a variable time interval depending on the statistical multiplexing in the transport stream. The interleaved unit 800 usually includes the plurality of TS packets. Individual interleaved units 800 are disposed alternately with each other for each angle number (#1-#3), as shown by arrows in the figure. That is, they are interleaved.

The aforementioned angle block is constructed with these interleaved blocks. Furthermore, in the interleaved block constructing the angle block, the reproduction start time point and the reproduction end time point of individual interleaved units 800 are synchronized for all angles.

As mentioned above, this interleaving makes it easy to perform the angle reproduction without lowering the transfer rate. Incidentally, some structure other than the angle block may be constructed with the interleaved block.

As shown in FIG. 19, especially in this embodiment, without a need to acquire the ES address information 134a (see FIG. 16 or the like) of the object information for every angle switching, the angle switching can be performed quickly and seamlessly as mentioned below, by referring to the address information within the navi packet disposed at the head of the interleaved unit 800.

More specifically, in FIG. 19, referring to the navi packet at the head of the interleaved unit (#1-1) makes it possible to start the reproduction of any interleaved unit (#1-2, #2-2, #3-2) corresponding to any angle, as shown by three arrows in the figure, after the reproduction of the navi pack. Incidentally, in this case, starting the reproduction of #1-2 means that the angle switching is not performed, and starting the reproduction of #2-2 or #3-2 means that the angle switching is performed.

Furthermore, firstly as a condition to perform the angle switching seamlessly, especially in this embodiment, as shown in FIG. 20, the navi packet 801 stores therein (i) angle number information indicating an angle number of an interleaved unit at least in which the navi packet is disposed at the head, (ii) angle quantity information indicating a quantity of switchable angles during the angle reproduction, and (iii) jump destination information of the next interleaved unit 800 for all the angles, indicating an angle number and a physical address and size (time interval) of the corresponding next interleaved unit 800.

More specifically, the navi packet 801a of angle #2-2 of title #1 shown in FIG. 18 and FIG. 19 has data contents shown in FIG. 21. Namely, the navi packet 801a has information indicating a physical address (packet number) and size (packet quantity) of the next interleaved unit for three angles #1-#3 respectively, in addition to “the number of the angle=2” and “the quantity of the angle=3”. Incidentally, the “number of packet” herein may be a serial numbers of packets assigned as a serial number within the interleaved unit as mentioned above, or may be a serial numbers of packets assigned as a serial number within the TS object. In the former and latter cases, the inherent advantage can be obtained respectively, as mentioned above.

FIG. 22 conceptually illustrates the interleaved unit 800a as a jump destination, indicated by the “the jump destination information of the next interleaved unit” in the navi pack 801a in this embodiment.

As shown in FIG. 22, on the basis of the address information stored in the navi packet 801a, it is possible to access (jump to) the interleaved unit 800a relating to video information of any angle, and thereby to perform the angle switching.

Incidentally, this access (jump) is made at a time point when the reproduction of the interleaved unit (#2-2) at whose head the navi pack is disposed completes. Thereby, obtaining the TS packet constructing the jump destination interleaved unit (i.e. the interleaved unit treated as the “next interleaved unit (ILVU)” by the navi pack 801, such as the interleaved unit #1-3, #2-3 and #3-3), until the completion of reproducing the interleaved unit stored temporarily in a buffer after a usual reading, and starting the reproduction of the selected jump destination interleaved unit 800a immediately after the completion of reproducing the interleaved unit makes it possible to provide a seamless reproduction.

Secondly as a condition to perform the angle switching seamlessly, especially in this embodiment, an array of TS packets (or source packets) in each interleaved unit 800 is to be the array shown in FIG. 23.

Namely, as shown in FIG. 23, the head packet of each interleaved unit 800 disposed in the interleaved block for the angle block is the navi packet 801. Furthermore, the packets after the head packet (after-second packets) start from a packet including a head data of I picture of a video stream of MPEG2.

Thirdly, as a condition to perform the angle switching seamlessly, especially in this embodiment, as shown in FIG. 24, the corresponding packet “display start time point”, “packet number” and “head I picture-indicating flag within the interleaved unit 800” are stored as the ES address information 134a (see FIG. 16) of the ES map table 134 relating to the video information for the angle reproduction. This flag value may be “1” for the head I picture entry (line) within the interleaved unit 800, and “0” for other entries (line), for example. This flag is used to facilitate finding the navi pack 800 in the case that the reproduction is started from a half way point of the interleaved unit 800. Incidentally, the way of finding the navi pack is discussed later.

In the ES address information shown in FIG. 24, a packet number and the corresponding display start time point of the I picture are preferably described. And the packet number and the like of the B or P picture is not preferably described or the packet number and the like of the audio information or sub-picture information is not preferably described. Thereby, in reproducing, the packet address can be identified on the basis of the packet number of the I picture, and the I picture can be reproduced on the basis of the corresponding display start time point. Furthermore, the B picture and the P picture can be reproduced on the basis of the I picture, and the audio or sub-picture information, if exists, corresponding to these video information can be reproduced. Especially in this occasion, since the B picture and P picture packet address information, and the corresponding audio information packet address information do not need to be described, the information volume to be recorded into a information record medium can be reduced as a whole.

Now, a reproduction principle of an angle block, using the interleaved unit 800, the navi packet 801, and the ES address information as shown in FIG. 24 is explained, with reference to FIG. 25 to FIG. 28. Incidentally, an actual reproduction of the angle block is performed by an information recording and reproducing apparatus mentioned below, on the basis of the reproduction principle now explained.

Firstly, with reference to FIG. 25, the reproduction principle for the “usual reproduction of the angle block (without the angle switching)” is explained along the operational flow.

(I) In this case, firstly, as shown by “Step 1” in FIG. 25, on the basis of the AU presented from the playlist and the PU belonged to the presented AU and corresponding to the angle designated by the user, the elementary stream packet ID (ES_PID) is obtained from the object information file by using the AU and the PU. And the ES address information (see FIG. 24) of the ES map table of the elementary stream which is identified by the obtained elementary stream packet ID is obtained.

(II) Next, as shown by “Step 2” in FIG. 25, by using the display start time point presented from the playlist, the entry which is identified by the presented display start time point is retrieved from the ES address information (see FIG. 24). And the packet number corresponding to the presented display start time point is obtained.

(III) Next, as shown by “Step 3” in FIG. 25, relative to the entry retrieved at the step 2, the entry whose ILVU head flag equals to 1 is retrieved. If ILVU head flag equals to 0, a search position is going toward the head in the ES address information (toward earlier display start time point) to retrieve the entry whose ILVU head flag equals to 1.

(IV) Next, as shown by “Step 4” in FIG. 25, the object data at a position corresponding to “the packet number −1”, the packet number being the packet number of the entry retrieved at the step 3, minus 1 is read.

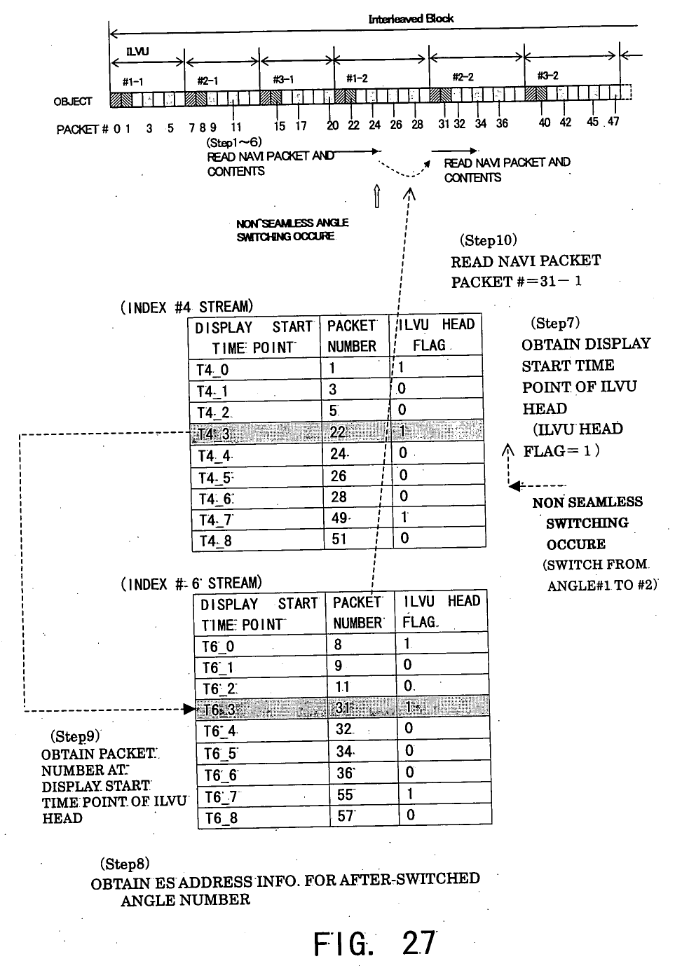

(V) Next, as shown by “Step 5” in FIG. 27, the object data is read from the position of the packet number of the entry obtained at the step 2.

(VI) Furthermore, as shown by “Step 6” in FIG. 27, on the basis of the address information of the next interleaved unit (ILVU) for all the angles, stored in the navi packet obtained at the step 4, the object data is read within the angle block. Incidentally, the navi packet is effective until the next one is read.

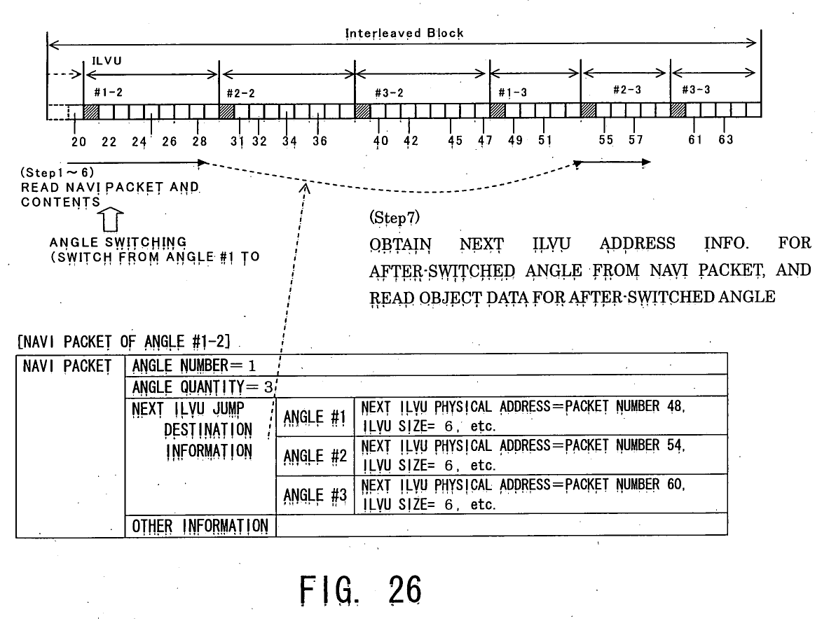

Next, with reference to FIG. 26, the reproduction principle on the “angle switching (with the seamless angle switching)” is explained along the operational flow.

(I)-(VI) Now, firstly, it is assumed that the usual reproduction explained with reference to FIG. 25 is performed.

(VII) In a case that the user switches the angle within the angle block at arbitrary time point, for example in a case that the angle is switched from angle #1 to angle #2, as shown by “Step 7” in FIG. 25, the address information of the next interleaved unit (ILVU) for the after-switched angle (angle #2) is obtained from the navi packet, and the object data of the next interleaved unit for the after-switched angle is read. This seamless angle switching can be performed by the interleaved unit (i.e. when the reproduction of the interleaved unit which is reproduced presently ends in switching the angle, the reproduction of another interleaved unit for another angle is started seamlessly).

Next, with reference to FIG. 27, the reproduction principle on the “angle switching (non-seamless angle switching)” is explained along the operational flow.

(I)-(VI) Now, firstly, it is assumed that the usual reproduction explained with reference to FIG. 25 is performed.

(VII) In a case that the use performs the non-seamless angle switching within the angle block at arbitrary time point, for example in a case that the angle is switched from angle #1 to angle #2, as shown by “Step 7” in FIG. 25, the entry whose ILVU head flag equals to 1 is retrieved from the ES address information (see FIG. 24 or the like) in order to obtain the head display start time point of the interleaved unit for which the angle is switched. If ILVU head flag equals to 0, search position is going toward the head of the ES address information (i.e. toward earlier display start time point) to retrieve the entry whose ILVU head flag equals to 1.

(VIII) Next, as shown by “Step 8” in FIG. 27, the ES address information (see FIG. 24 or the like) corresponding to the angle number after switching the angle is obtained from the AU table 131 (see FIG. 16 or the like).

(IX) Next, as shown by “Step 9” in FIG. 17, with reference to the ES address information (see FIG. 24 or the like) obtained at the step 8, the packet number corresponding to the display start time point obtained at the step 7.

Then, the object data of the next interleaved unit for the after-switched angle is read, including the “packet number −1”, the packet number being obtained at the step 9, i.e. including the navi pack. The “non-seamless angle switching” herein means that switching the angle at the same time point as the head display start time point of the present interleaved unit. However, it is possible to switch the angle non-seamlessly, with a somewhat time extended back.

In any case, in this embodiment, although it is possible to perform the seamless angle switching, it may be possible to perform optionally the non-seamless angle switching like this.

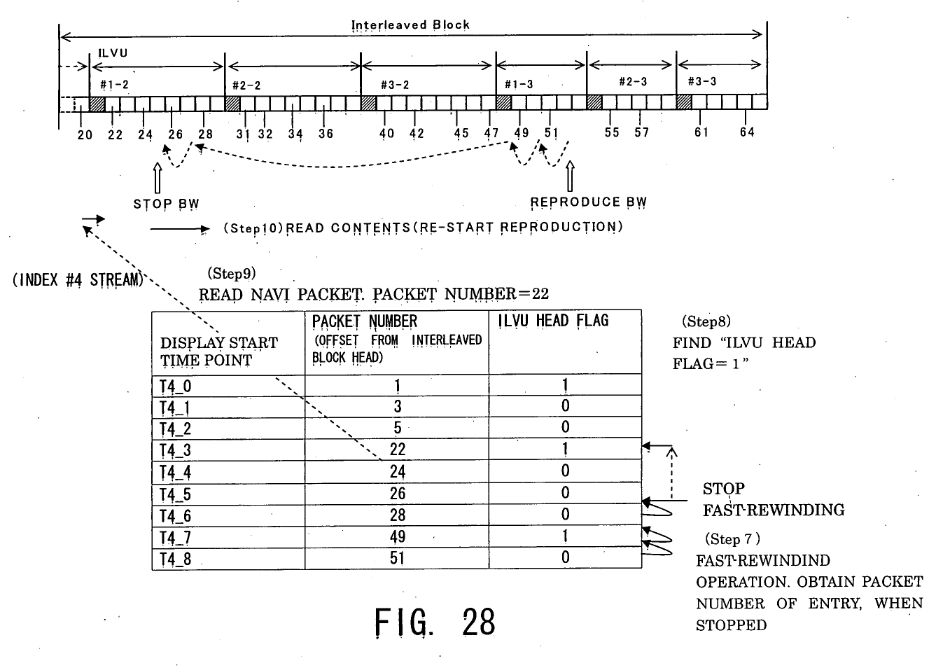

Next, with reference to FIG. 28, the reproduction principle of the “fast-forwarding/fast-rewinding” is explained.

(I)-(VI) Now, firstly, it is assumed that the usual reproduction explained with reference to FIG. 25 is performed.

(VII) If the user performs the instruction of fast-forwarding/fast-rewinding in the angle block at arbitrary time point, packet numbers are obtained sequentially forward or backward from the entry of the display start time point of each address information, at which the fast-forwarding/fast-rewinding is started, by using the ES address information as shown by “Step 7” in FIG. 28. And the corresponding object data is read and displayed. After these operations end, the packet number of the entry at which these operations end is obtained.

(VIII) As shown by “Step 8” in FIG. 28, relative to the entry obtained at the step 7, the entry whose ILVU head flag equals to 1 is retrieved. If ILVU head flag equals to 0, the search point is toward the head of the ES address information (toward earlier display start time point) to retrieve the entry whose ILVU head flag equals to 1.

(IX) Next, as shown by “Step 9” in FIG. 28, the object data at a position corresponding to “packet number −1” (i.e. navi packet), the packet number being the packet number of the corresponding entry retrieved at the step 8, is read.

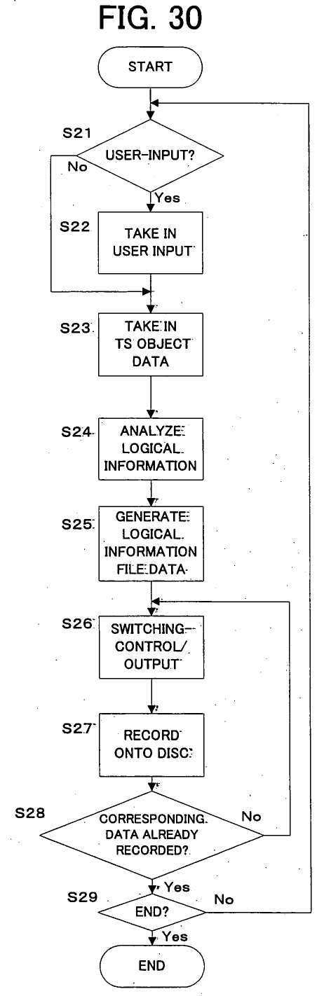

Furthermore, as shown by “Step 10” in FIG. 30, the object data is read, from the packet number position of the entry obtained at the step 7.

As mentioned above in detail, in this embodiment, the recording on the optical disc 100 is performed in a multiplex manner by source packet unit 144 or TS packet unit 146. Thereby, the transport stream including a plurality of elementary stream as shown in FIG. 2(b) can be recorded in the multiplex manner onto the optical disc 100. In this embodiment, a plurality of programs or the like can be recorded in the usual block simultaneously with the limit of recording rate. Especially in the angle block, a plurality of angles can be recorded simultaneously with the limit of the recording rate. The recorded optical disc 100 can be reproduced in the seamless angle reproduction, especially in the angle block, according to the reproduction principle shown by FIG. 25 to FIG. 28 mentioned above. Hereinafter, examples of the information recording and reproducing apparatus capable of performing the aforementioned recording and reproducing are explained.

(Information Recording/Reproducing Apparatus)

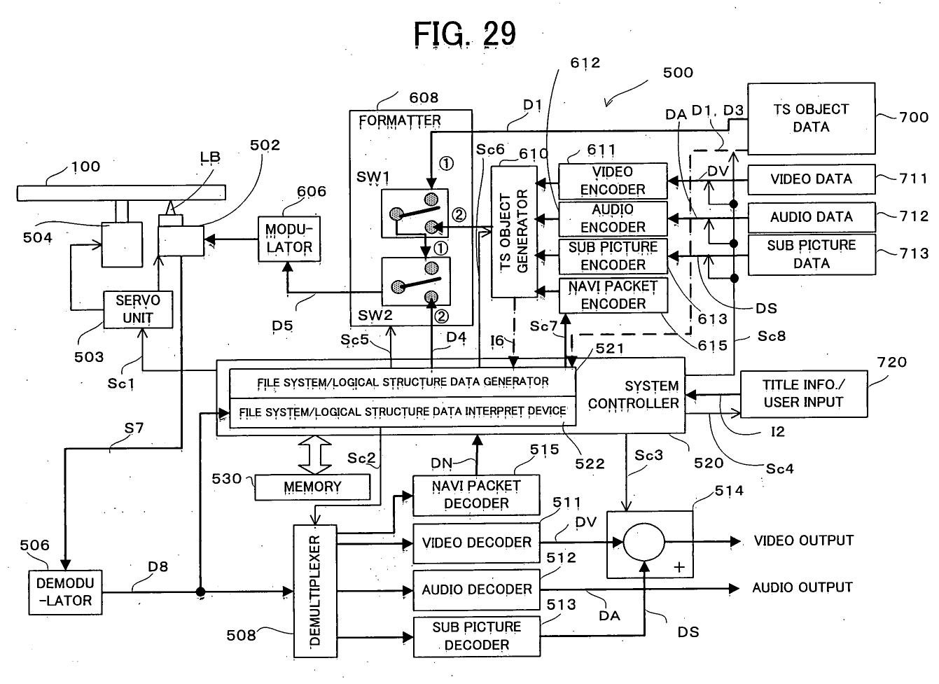

Next, the embodiment of the information recording/reproducing apparatus of the present invention will be explained with reference to FIG. 29 to FIG. 38. FIG. 29 is a block diagram of the information recording/reproducing apparatus, and FIG. 30 to FIG. 38 are flow charts showing its operation.

In FIG. 29, an information recording/reproducing apparatus 500 is classified broadly into a reproduction system and a record system, can record information onto the optical disc 100 described above, and can reproduce the information recorded on this. In this embodiment, the information recording/reproducing apparatus 500 is for recording and reproducing as described above, but it is possible to construct an embodiment of the recording apparatus of the present invention from the record system part of the information recording/reproducing apparatus 500. On the other hand, it is possible to construct an embodiment of the reproducing apparatus of the present invention from the reproduction system part of the information recording/reproducing apparatus 500.

The information recording/reproducing apparatus 500 is provided with: an optical pickup 502; a servo unit 503; a spindle motor 504; a demodulator 506; a demultiplexer 508; a video decoder 511; an audio decoder 512; a sub-picture decoder 513; a navi pack decoder 515; an adder 514; a system controller 520; a memory 530; a modulator 606; a formatter 608; a TS object generator 610; a video encoder 611; an audio encoder 612; a sub-picture encoder 613; and a navi pack encoder 615. The system controller 520 is provided with a file system/logical structure data generator 521; and a file system/logical structure data interpret device 522. Moreover, the memory 530 and a user interface 720 for the user input of the title information and the like are connected to the system controller 520.

Among these constitutional elements, the demodulator 506, the demultiplexer 508, the video decoder 511, the audio decoder 512, the sub-picture decoder 513, the navi pack decoder 515 and the adder 514 constitute the reproduction system, mostly. On the other hand, among these constitutional elements, the modulator 606, the formatter 608, the TS object generator 610, the video encoder 611, the audio encoder 612, the sub-picture encoder 613 and the navi pack encoder 615 constitute the record system, mostly. The optical pickup 502, the servo unit 503, the spindle motor 504, the system controller 520, the memory 530, and the user interface 720 for the user input of the title information and the like are shared for both the reproduction system and the record system, mostly. Moreover, a TS object data source 700, a video data source 711, an audio data source 712, and a sub-picture source 713 are prepared for the record system. The file system/logical structure data generator 521 installed in the system controller 520 is mainly used in the record system, and the file system/logical structure data interpret device 522 is mainly used in the reproduction system.

The optical pickup 502 irradiates a light beam LB, such as a laser beam, onto the optical disc 100 with a first power as a reading light when reproducing, and with a second power as a writing light when recording while modulating it. The servo unit 503 is controlled by a control signal Sc1 outputted from the system controller 520 when reproducing and recording, and it performs a focus servo, a tracking servo, and the like at the optical pickup 502, as well as performing a spindle servo at the spindle motor 504. The spindle motor 504 is constructed to spin the optical disc 100 at a predetermined speed while receiving the spindle servo by the servo unit 503.

In FIG. 29, especially in this embodiment, the navi packet decoder 515 is disposed at an output side of the demultiplexer 508 with the video decoder 511 side by side. The aforementioned navi packet disposed at the head of the interleaved packet is inputted into the navi packet decoder 515, for reproducing the angle block. The navi packet decoder 515 outputs information DN, such as the angle number, the angle quantity, the address information and so on (see FIGS. 20 and 21 etc.), which is obtained by decoding the inputted navi packet, to the file system/logical structure data interpret device 522. The address information and so on stored in the navi packet are used for the pickup control or the like relative to the interleaved block.

Furthermore, especially in this embodiment, the navi packet encoder 615 is disposed at an input side of the TS object generator 610 with the video encoder 611 side by side. The navi packet encoder 615 encodes the angle number, the angle quantity, the address information and so on (see FIGS. 20 and 21 etc.), in generating the angle block, under control of the system controller 520 via the control signal Sc7. The TS object generator 610 outputs the encoded information as the navi packet to the formatter 608 at a predetermined timing to dispose the navi packet at the head of the interleaved packet in the transport stream.

(i) Structure and Operation in Record System

Next, the specific structure and operation of each constitutional element constituting the record system in the information recording/reproducing apparatus 500 will be explained case by case, with reference to FIG. 29 to FIG. 33.

(i-1) The Case of Using the Already Prepared TS Object:

This case will be explained with reference to FIG. 29 and FIG. 30.

In FIG. 29, the TS object data source 700 is provided with a record storage, such as a video tape and a memory, and it stores TS object data D1.

In FIG. 30, firstly, the information about each title (e.g. the structure content of a play list and the like) logically constructed on the optical disc 100 using the TS object data D1 is inputted from the user interface 720 to the system controller 520, as a user input 12 of the title information and the like. Then, the system controller 520 takes in the user input 12 of the title information and the like obtained from the user interface 720 (step S21: Yes and step S22). In this case, the user interface 720 is controlled by a control signal Sc4 from the system controller 520, and it can perform input processing according to the content to be recorded, such as choosing through a title menu screen. Incidentally, in the case where the user input has been already performed or the like (step S21: No), this processing is omitted.

Then, the TS object data source 700 is controlled by a control signal Sc8 giving an instruction for reading out the data from the system controller 520, and outputs the TS object data D1. Then, the system controller 520 takes in the TS object data D1 from the TS object source 700 (step S23), and performs the analysis of the data array of the TS object data D1 (e.g. a record data length and the like), the analysis of each elementary stream structure (e.g. understanding of ES_PID (Elementary Stream Packet Identification number) as described later), and the like, by virtue of a TS analysis function of the file system/logical structure data generator 521, for example, on the basis of the PAT, the PMT, and the like packetized as well as the video data and the like as described above (step S24).

Then, the system controller 520 prepares the disc information file 110, the play list information file 120, the object information file 130, and the file system 105 (refer to FIG. 3), as logical information file data D4, by virtue of the file system/logical structure data generator 521, from the user input 12 of the taken-in title information and the like and from the analysis results of the data array of the TS object data D1 and each elementary stream (step S25). The memory 530 is used when preparing the logical information file data D4 described above.

Incidentally, such a variation that the data about the data array of the TS object data D1, the data about the construction information of each elementary stream, and the like are prepared in advance, is apparently and variously conceivable. Such a variation is also within the scope of the embodiment.

In FIG. 29, the formatter 608 is a device for performing a data array format to store onto the optical disc 100 the TS object data D1 and the logical information file data D4. More specifically, the formatter 608 is provided with a switch Sw1 and a switch Sw2 and is switching-controlled by a switch control signal Sc5 from the system controller 520. When formatting the TS object data D1, it connects the switch Sw1 to a \textcircled{1} side and the switch Sw2 to the \textcircled{1} side so as to output the TS object data D1 from the TS object data source 700. Incidentally, the transmission control of the TS object data D1 is performed by the control signal Sc8 from the system controller 520. On the other hand, when formatting the logical information file data D4, the formatter 608 is switching-controlled by the switch control signal Sc5 from the system controller 520, and connects the switch Sw2 to a \textcircled{2} side so as output the logical information file data D4.

In a step S26 in FIG. 30, (i) the logical information file data D4 from the file system/logical structure data generator 521 at the step S25 or (ii) the TS object data D1 from the TS object data source 700 is outputted through the formatter 608 by the switching-control by the formatter 608 as constructed above (step S26).

The selection output from the formatter 608 is transmitted to the modulator 606 as disc image data D5, is modulated by the modulator 606, and is recorded onto the optical disc 100 through the optical pickup 502 (step S27). The system controller 520 also executes the disc record control in this case.

Then, if both the logical information file data D4 generated at the step S25 and the corresponding TS object data D2 have not been completely recorded yet, the operational flow returns to the step S26, continuing to the record (step S28: No). Incidentally, there is no preference in the record order of the logical information file data D4 and the corresponding TS object data D2.

On the other hand, if the both have been already recorded, it is judged whether or not the record on the optical disc 100 is supposed to be ended, on the basis of the presence or absence of an end command (step S29). If not supposed to be ended (step S29: No), the operational flow returns to the step S21, continuing the record processing. On the other hand, if supposed to be ended (step S29: Yes), a series of record processing ends.

As described above, the information recording/reproducing apparatus 500 performs the record processing in the case of using the already prepared TS object.

Especially in this embodiment, at the step S25 and the like, the interleaved unit is generated from the array of the TS packets on the basis of the statistical multiplexing system. Furthermore, the navi packet including the angle number, the angle quantity, the address information and so on (see FIGS. 20 and 21 etc.) is generated. At the aforementioned step S26, the formatter 608 performs the switching control so that the generated navi packet is disposed at the head of each interleaved packet.

Incidentally, the example in FIG. 30 shows that the logical information file data D4 and the corresponding TS object data D2 are outputted at the step S26, after preparing the logical information file data D4 at the step S25. However, it is also possible to execute the output of the TS object data D2 and/or the record of the TS object data D2 onto the optical disc 100 before the step S25, and after or in parallel with this recording, it is possible to generate and record the logical information file data D4.

(i-2) The Case of Receiving and Recording the Transport Stream on Air

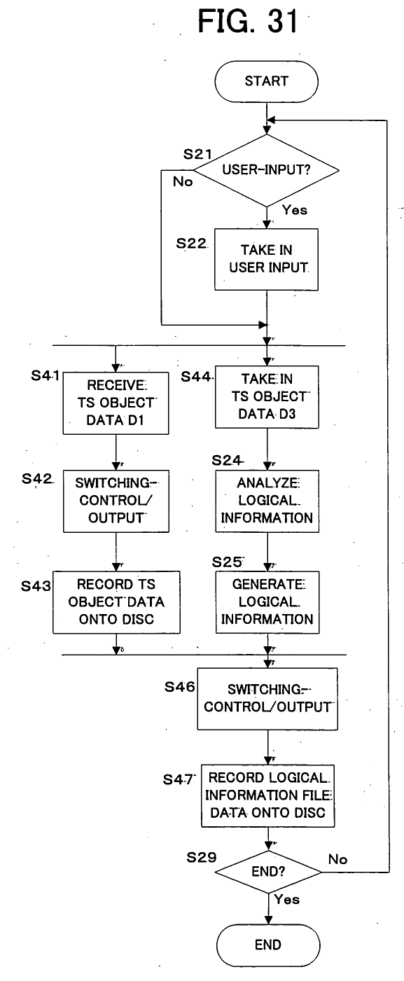

This case will be explained with reference to FIG. 29 and FIG. 31. Incidentally, in FIG. 31, the same steps as those in FIG. 30 have the same step reference numbers, and their explanation will be omitted as occasion demands.

Again, in this case, the similar processing is performed, as is “the case of using the already prepared TS object” described above. Therefore, focusing on the differences from this case, the explanation will be done hereinafter.

In the case of receiving and recording the transport stream on air, or the transport stream being broadcasted, the TS object data source 700 is provided with a receiver (set top box) for receiving the digital broadcast on air, for example, receives the TS object data D1, and transmits it to the formatter 608 in real time (step S41). At the same time, reception information D3 (i.e. information corresponding to the data transmitted through the receiver and the interface of the system controller 520) including the program construction information and the ES_PID information, as described later, which are deciphered upon receiving is taken into the system controller 520 and is stored into the memory 530 (step S44).

In the meantime, the TS object data D1 outputted to the formatter 608 is outputted to the modulator 606 by the switching-control of the formatter 608 (step S42), and is recorded onto the optical disc 100 (step S43).

Along with these operations, using the program construction information and the ES_PID information included in the reception information D3 taken-in upon receiving and stored in the memory 530, the file system/logical structure data generator 521 prepares the logical information file data D4 (step S24 and step S25). Then, after completing the record of a series of the TS object data D1, this logical information file data D4 is additionally recorded onto the optical disc 100 (step S46 and step S47). Incidentally, these step S24 and step S25 may be performed after the step S43.

Moreover, as the occasion demands (e.g. in the case of editing one portion of the title, or the like), by adding the user input 12 of the title information and the like from the user interface 720 to the program construction information and the ES_PID information stored in the memory 530, it is possible to prepare the logical information file data D4 by the system controller 520 and additionally record this onto the optical disc 100.

As described above, the information recording/reproducing apparatus 500 performs the record processing in the case of receiving the transport stream on air and recording it in real time.

Especially in this embodiment, at the aforementioned step S25 and the like, the interleaved unit is generated from the array of the TS packets on the basis of the statistical multiplexing system. Furthermore, the navi packet including the angle number, the angle quantity, the address information and so on (see FIGS. 20 and 21 etc.). At the aforementioned step S46, the formatter 608 performs the switching control so that the generated navi packet is disposed at the head of each interleaved packet.

Incidentally, if all the reception data obtained when broadcasting is once stored into an archive apparatus, and then, if this is used as the TS object source 700, the same processing as that in “the case of using the already prepared TS object” will do.

(i-3) The Case of Recording the Video Data, the Audio Data, and the Sub-Picture Data

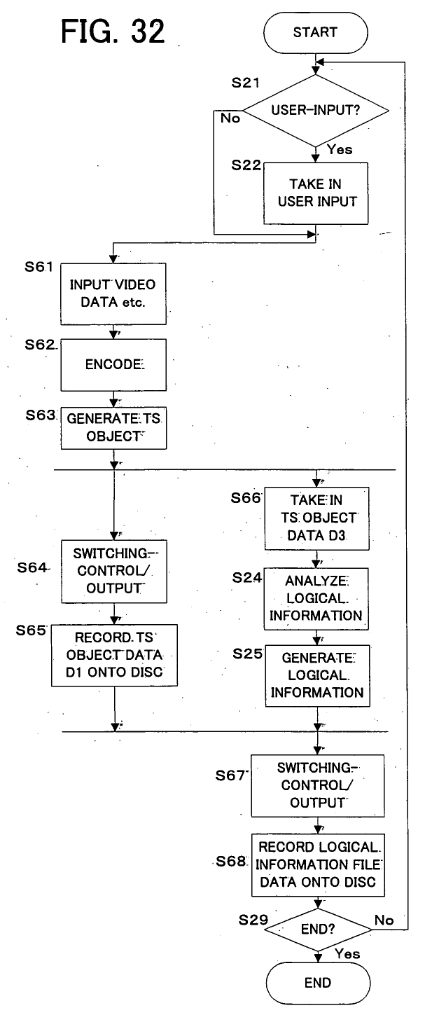

This case will be explained with reference to FIG. 29 and FIG. 32. Incidentally, in FIG. 32, the same steps as those in FIG. 30 have the same step reference numbers, and their explanation will be omitted as occasion demands.

In the case of recording the video data, the audio data, and the sub-picture data, which are individually prepared in advance, the video data source 711, the audio data source 712, and the sub-picture data source 713 are individually provided with the record storage, such as a video tape and a memory, and store a video data DV, an audio data DA, and a sub-picture data DS, respectively.

These data sources are controlled by the control signal Sc8 giving an instruction for reading out the data from the system controller 520, and they transmit the video data DV, the audio data DA, and the sub-picture data DS, to the video encoder 611, the audio encoder 612, and the sub-picture encoder 613, respectively (step S61). Then, the video encoder 611, the audio encoder 612, and the sub-picture encoder 613 execute a predetermined type of encode processing (step S62).

The TS object generator 610 is controlled by a control signal Sc6 from the system controller 520 and converts the data encoded in this manner to the TS object data constituting the transport stream (step S63). In this case, the data array information of each TS object data (e.g. a record data length and the like) and the construction information of each elementary stream (e.g. the ES_PID, as described later, and the like) are transmitted from the TS object generator 610 as information 16 to the system controller 520 and are stored into the memory 530 (step S66).

On the other hand, the TS object data generated by the TS object generator 610 is transmitted to the \textcircled{2} side of the switch Sw1 of the formatter 608. Namely, when formatting the TS object data from the TS object generator 610, the formatter 608 is switching-controlled by the switch control signal Sc5 from the system controller 520 to change the switch Sw1 to the \textcircled{2} side and the switch Sw2 to the \textcircled{1} side, thereby outputting the TS object data (step S64). Then, this TS object data is recorded onto the optical disc 100 through the modulator 606 (step S65).

Along with these operations, using the data array information of each TS object data and the construction information of each elementary stream taken into the memory 530 as the information 16, the file system/logical structure data generator 521 prepares the logical information file data D4 (step S24 and step S25). Then, after completing the record of a series of the TS object data D1, this is additionally recorded onto the optical disc 100 (step S67 and step S68). Incidentally, the step S24 and the step S25 may be processed after the step S65.

Moreover, as the occasion demands (e.g. in the case of editing one portion of the title), by adding the user input 12 such as the title information and the like from the user interface 720 onto these information stored in the memory 530, it is possible to prepare the logical information file data D4 by the file system/logical structure generator 521 and additionally record this onto the optical disc 100.

As described above, the information recording/reproducing apparatus 500 performs the record processing in the case of the recording the video data, the audio data, and the sub-picture data, which are individually prepared in advance.

Especially in this embodiment, at the aforementioned step S25, the interleaved unit is generated from the array of the TS packets on the basis of the statistical multiplexing system. Furthermore, the navi packet including the angle number, the angle quantity, the address information and so on (see FIGS. 20 and 21 etc.) is generated. At the aforementioned step S67, the formatter 608 performs the switching control so that the generated navi packet is disposed at the head of each interleaved packet.

Incidentally, this record processing is applicable even when recording an arbitrary content the user has.

(i-4) The Case of Recording the Data by Authoring

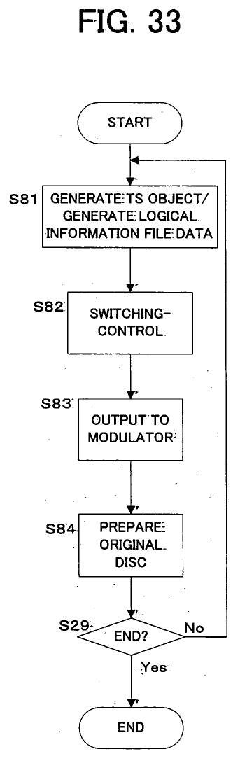

This case will be explained with reference to FIG. 29 and FIG. 33. Incidentally, in FIG. 33, the same steps as those in FIG. 30 have the same step reference numbers, and their explanation will be omitted as occasion demands.

In this case, by combining the above described three types of record processing in the three cases, an authoring system generates the TS object, the logical information file data, and the like in advance (step S81), and then completes the processing of switching-control performed at the formatter 608 (step S82). Then, the information obtained by this operation is transmitted to the modulator 606 equipped in front of and/or behind an original disc cutting machine, as the disc image data D5 (step S83), and this cutting machine prepares the original disc (step S84).

(ii) Structure and Operation in Reproduction System

Next, the specific structure and operation of each constitutional element constituting the reproduction system in the information recording/reproducing apparatus 500 will be explained with reference to FIG. 29 and FIG. 34 to FIG. 38.

The user interface 720 inputs the title to be reproduced, its reproduction condition, and the like, to the system controller 520, as the user input 12 of the title information and the like. In this case, the user interface 720 is controlled by the control signal Sc4 from the system controller 520, and it can perform the input processing according to the content to be reproduced, such as choosing through a title menu screen.

Responding to this, the system controller 520 controls the disc reproduction with respect to the optical disc 100, and the optical pickup 502 transmits a reading signal S7 to the demodulator 506.

The demodulator 506 demodulates a recorded signal recorded on the optical disc 100 from this reading signal S7, and outputs it as demodulated data D8. The logical information file data (i.e. the file system 105, the disc information file 110, the P list information file 120, and the object information file 130, shown in FIG. 3) included in this demodulated data D8 as being a not-multiplexed information part is supplied to the system controller 520. On the basis of this logical information file data, the system controller 520 executes various reproduction control, such as processing of determining a reproduction address and controlling the optical pickup 502.

On the other hand, as for the TS object data included in the demodulated data D8 as being a multiplexed information part, the demultiplexer 508 is controlled by a control signal Sc2 from the system controller 520 to demultiplex the TS object data. Here, the control signal Sc2 is transmitted so as to start demultiplexing when completing an access to a reproduction position address by the reproduction control of the system controller 520.

The demultiplexer 508 transmits and supplies the video packet, the audio packet, and the sub-picture packet, to the video decoder 511, the audio decoder 512, and the sub-picture decoder 513, respectively. Then, the video data DV, the audio data DA, and the sub-picture data DS are respectively decoded.

Incidentally, the packets included in the transport stream, in each of which the PAT or the PMT is packetized as shown in FIG. 6, are respectively included as a part of the demodulated data D8; however, they are discarded or abandoned at the demultiplexer 508.

The adder 514 is controlled by a control signal Sc3 giving an instruction of the mixing from the system controller 520, and mixes or superimposes in a predetermined timing the video data DV and the sub-picture data DS, which are respectively decoded at the vide decoder 511 and the sub-picture decoder 513. The result is outputted as a video output from the information recording/reproducing apparatus 500 to a TV monitor, for example.

On the other hand, the audio data DA decoded at the audio decoder 512 is outputted as an audio output from the information recording/reproducing apparatus 500 to an external speaker, for example.

Especially in this embodiment, when at least the angle block is reproduced, the aforementioned navi packet disposed at the head of the interleaved packet is transmitted from the demultiplexer 508 and is inputted into the navi packet decoder 515. Then, the information DN obtained by decoding the inputted navi packet is outputted from the navi packet decoder 515 to the file system/logical structure interpret device 522 in the system controller 520. Next, on the basis of the information DN, the pickup control and the like is performed relative to the interleaved block. Then, if the execution command for the angle switching is inputted, as the user input 12 through the user interface, into the system controller 520, the angle switching is performed seamlessly, as mentioned above, on the basis of the information DN in the navi packet interpreted at the file system/logical structure interpret device 522.

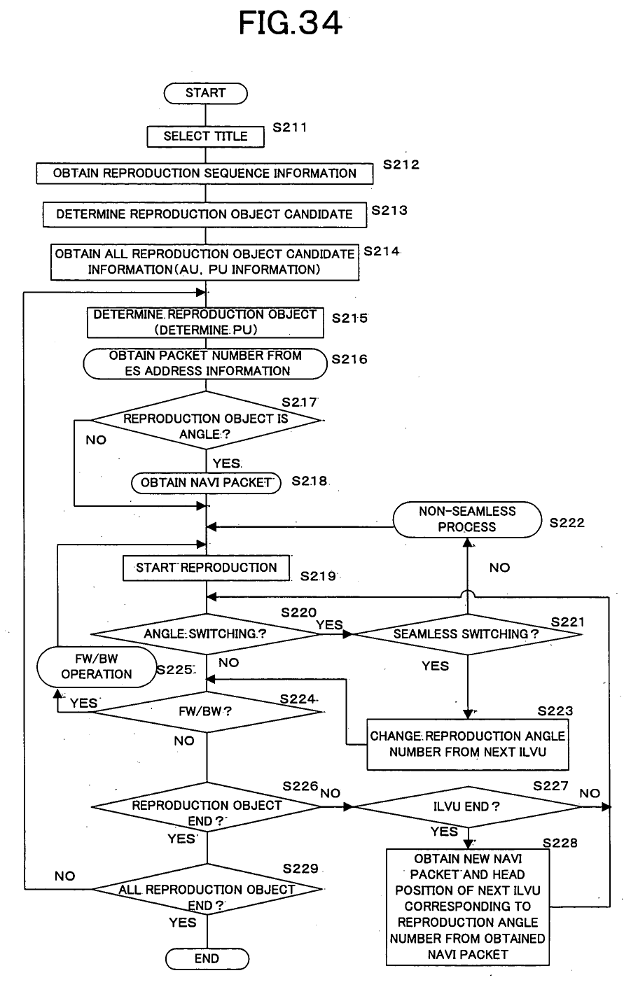

Here, the specific example of a reproduction processing routine by the system controller 520 will be explained with reference to FIG. 34 to FIG. 38.

With reference to FIG. 34, a general flow of the reproduction processing will be explained.

In FIG. 34, assume that as an initial condition, the recognition of the optical disc 100 in the reproduction system and the recognition of a volume structure and a file structure by the file system 105 (refer to FIG. 3) have been already completed by the system controller 520 and the file system/logical structure data interpret device 522 inside the system controller 520. Here, it will be explained the operational flow after obtaining the total quantity of the total titles from the disc comprehensive information 112 in the disc information file 110 and then choosing or selecting one title from among them.

Firstly, the choice or selection of the title is performed at the user interface 720 (step S211), and the system controller 520 obtains the information about the reproduction sequence from a reading result of the file system/logical structure data interpret device 522. More specifically, the processing of the logical hierarchy (i.e. obtaining the information for indicating a play list structure and the information about each of the Items constituting the play list structure (refer to FIG. 7)) is performed (step S212). By this, a reproduction object is determined (step S213).

Then, the object information file 130 related to the TS object as being the reproduction object is obtained. Especially in the embodiment, the AU table 131 (see FIG. 16 and so on) including, as mentioned above, the AU information 132I and PU information 302I is also obtained as the information stored in the object information file 130 (step S214). These obtained information allow the association or correlation of the above described logical hierarchy and the object hierarchy (refer to FIG. 7).

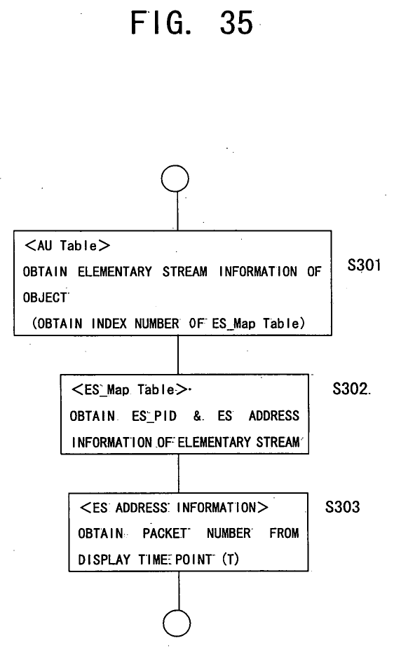

Then, on the basis of the information obtained at the step S214, the object to be reproduced, i.e. the PU is determined (step S215), and then the packet number relating to the TS object to be reproduced is obtained from the ES address information included in the ES map table (see FIG. 16, FIG. 24, and so on) (step S216). Incidentally, this packet obtaining process at the step S216 will be explained later with reference to FIG. 35.

At this stage, it is judged whether or not the TS object to be reproduced is for the angle reproduction, for example on the basis of the AU attribute information in the AU table 131 (see FIG. 16 and so on) (step S217).

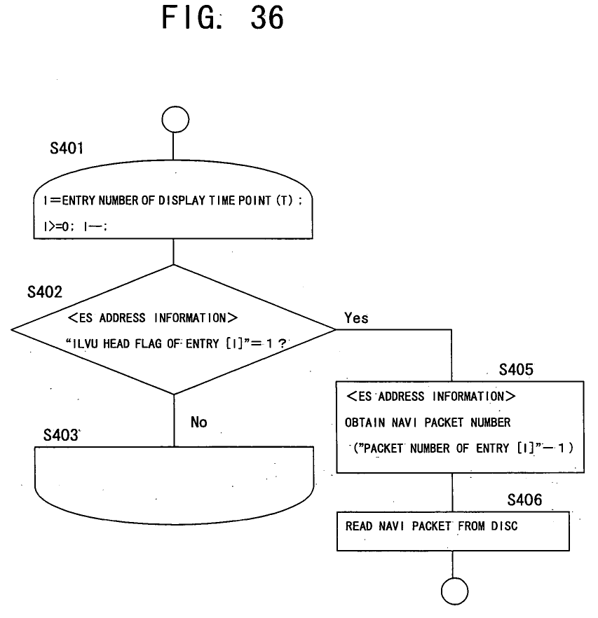

As a result, if it is judged that it is for the angle reproduction (step S217: Yes), the navi packet is obtained (step S218) and then the reproduction is started (step S219). On the other hand, if it is judged that it is not for the angle reproduction (step S217: No), since the navi packet does not need to be obtained, the reproduction is started without obtaining the navi pack (step S219). Incidentally, the navi packet obtaining process at step S218 will be explained later, with reference to FIG. 36.

Then, during the reproduction of the object, it is judged whether or not the existence of the user input command for the angle switching in the information recording and reproducing apparatus (step S220).

If it is judged that the command for the angle switching exists (step S220: Yes), it is judged whether or not the seamless switching is set to perform the angle reproduction, on the basis of the user input or an initial setting in the information recording and reproducing apparatus (step S221).

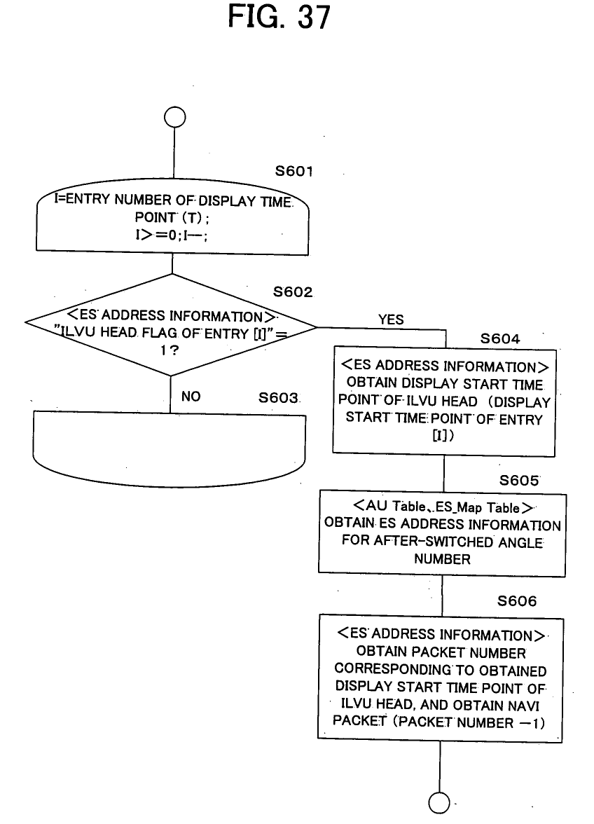

As a result, if it is judged that the seamless switching is not set (step S221: No), for example if the aforementioned non-seamless switching is set, the non-seamless processing is executed (step S222) and then the reproduction is started (step S219). Incidentally, the non-seamless processing at step S222 will be explained with reference to FIG. 37. On the other hand, if the seamless switching is set (step S221: Yes), the object to be reproduced after switching the angle is determined. More specifically, the angle number corresponding to the user operation is determined (step S223).

On the other hand, at step S220, if it is judged that the command for the angle switching does not exist (step S220: No), it is judged whether or not a command is inputted for fast-forwarding/fast-rewinding (step S224).

As a result, if it is judged that the command for fast-forwarding/fast-rewinding is inputted (step S224: Yes), the fast-forwarding/fast-rewinding processing is executed (step S225) and then the reproduction is started (step S219).

On the other hand, if it is judged that the command for fast-forwarding/fast-rewinding is not inputted (step S224: No), it is judged whether or not the object to be reproduced completes (step S226). As a result, if it is judged that the object to be reproduced does not complete (step S226: No), it is judged whether or not the interleaved unit completes (step S227). As a result, if it is judged that the interleaved unit completes (step S227: Yes), a head position of the next interleaved unit corresponding to the reproduction angle number is obtained from the obtained navi packet, and the object data is read from the obtained position to obtain the navi packet and to continue the reproduction (step S228). On the other hand, if it is judged that the interleaved unit does not complete (including the case of the usual block) (step S227: No), the object data is continuously read and the reproduction is continued. On the other hand, if it is judged that the object to be reproduced completes (step S226: Yes), it is judged whether or not all the objects to be reproduced complete (step S229).

As a result, if it is judged that all the objects to be reproduced do not complete (step S229: No), the operational flow goes back to step S215 to continue a series of reproduction processings. On the other hand, if it is judged that all the objects to be reproduced complete (step S229: Yes), a series of reproduction processings ends.

Next, with reference to FIG. 35, the packet number obtaining process at step S216 in FIG. 34 will be explained.

In FIG. 35, firstly, with reference to the AU table (see FIG. 16 and so on), the information about the elementary stream of the TS object to be reproduced is obtained. Namely, the index number and the like of the ES map table is obtained (step S301).

Next, with reference to the ES map table (see FIG. 16 and so on), the ES address information and the packet number (ES_PID) of the elementary stream corresponding to the index number obtained at step S301 are obtained (step S302).

Next, on the basis of the obtained ES address information (see FIG. 24 and so on), the corresponding packet number is obtained from the display time point (T) (step S303).

Thus, the packet number obtaining process completes.

Next, with reference to FIG. 36, the navi packet obtaining process at step S218 in FIG. 34 will be explained.

Firstly in FIG. 36, the initial value of the parameter I to retrieve the navi packet is set to the entry number (e.g. a line number of the ES address information in FIG. 24) corresponding to the display time point (T) (step S401).

Next, with reference to the ES address information, it is judged whether or not the head flag of the interleaved unit (ILVU) having the entry number “I” is “1” (step S401). Then, if it is judged that the head flag is “1” (step S402: Yes), the operational flow escapes from a loop from step S401 to S403 and branches into step S405. On the other hand, if it is judged that the head flag is not “1” (step S402: No), the loop from step S401 to S403 is repeated with “I” being decremented under a condition “I”≧0. Finally, if it is judged that the head flag is “1” (step S402: Yes), the operational flow escapes from the loop from step S401 to S403 and branches into step S405.

Next, at step S405, with reference to the ES address information (see FIG. 24 and so on), the packet number of the navi packet is obtained. More specifically, the immediately precedent packet number of the packet number having the entry number “I” when it is judged the head flag is “1” at step S402 (i.e. “the packet number of the entry number “I”−1) is obtained.

Then, the navi packet is obtained by reading the information from the record position corresponding to this packet number on the optical disc 100 (step S406).

Thus, the navi packet obtaining process ends.

Next, with reference to FIG. 37, the non-seamless process at step S222 in FIG. 34 will be explained.

Firstly in FIG. 37, the initial value of the parameter I to obtain the head display start time point of the interleaved unit in which the angle is switched is set to the entry number (e.g. a line number of the ES address information in FIG. 27) corresponding to the display time point (T) when the non-seamless angle switching is occurred (step S601).

Next, with reference to the ES address information, it is judged whether or not the head flag (see FIG. 27 and so on) of the interleaved unit (ILVU) having the entry number “I” is “1” (step S602). Then, if it is judged that the head flag is “1” (step S602: Yes), the operational flow escapes from a loop from step S601 to S603 and branches into step S604. On the other hand, if it is judged that the head flag is not “1” (step S602: No), the loop from step S601 to S603 is repeated with “I” being decremented under a condition “I”≧0. Finally, if it is judged that the head flag is “1” (step S602: Yes), the operational flow escapes from the loop from step S601 to S603 and branches into step S604.

Next, at step S604, with reference to the ES address information (see FIG. 27 and so on), the head display start time point of the interleaved unit in which the angle is switched is obtained. More specifically, the display start time point of the packet number having the entry number “I” when it is judged the head flag is “1” at step S602 is obtained.

Then at step S605, the ES address information corresponding to the angle number after the angle is switched is obtained. Especially in this embodiment, the ES address information included in the ES map table (see FIG. 16, FIG. 27 and so on) is obtained on the basis of the AU information 132I and the PU information 302I, as mentioned above.

Next, at step S606, with reference to the ES address information (see FIG. 27 and so on) obtained at step S605, the packet number corresponding to the display start time point obtained at step S604 is obtained. The navi packet is obtained by reading the information from the record position corresponding to “the packet number −1” on the optical disc 100.

Thus, the non-seamless process ends.

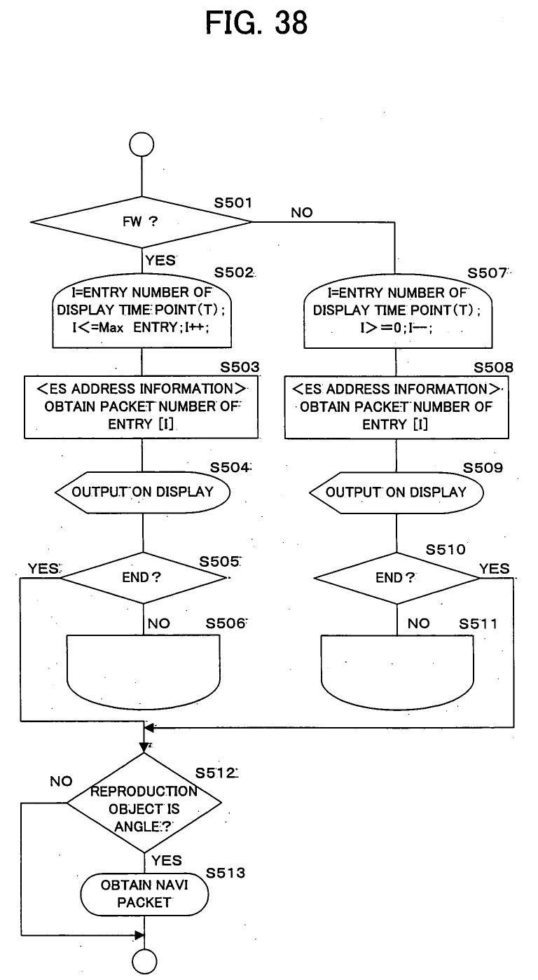

Next, with reference to FIG. 38, the fast-forwarding/fast-rewinding process at step S227 in FIG. 34 will be explained.

Firstly in FIG. 38, it is judged whether or not a command for fast-forwarding is inputted (step S501).

As a result, if it is judged that the command for fast-forwarding is inputted (step S501: Yes), the initial value of the parameter “I” for the fast-forwarding control is set to the entry number (e.g. a line number of the ES address information in FIG. 24) corresponding to the display time point (T) (step S502).

Next, with reference to the ES address information, the packet number having the entry number “I” is obtained (step S503), the corresponding packet is reproduced, so that a fast-forwarding display is performed on the display (step S504). Then, it is judged whether or not a command to stop the fast-forwarding process is inputted (step S505). If it is judged that the command to stop the fast-forwarding process is inputted (step S505: Yes), the operational flow escapes from a loop from S502 to S506, and a series of fast-forwarding process ends. On the other hand, if it is judged that the command to stop the fast-forwarding process is not inputted (step S505: No), the loop from S502 to S506 is repeated with “I” being incremented under a condition I≦the max entry (in which the max entry means the maximum line numbers available for the entry in the ES address information). Finally, if it is judged that the command to stop the fast-forwarding process (step S505: Yes), the operational flow escapes from the loop from S502 to S506 and a series of the fast-forwarding processes ends.

On the other hand, if it is judged at step S501 that the command for the fast-forwarding process is not inputted (step S501: No), the initial value of the parameter “I” for the fast-rewinding control is set to the entry number (e.g. a line number of the ES address information in FIG. 28) corresponding to the display time point (T), in order to perform the fast-rewinding process (step S507).

Next, with reference to the ES address information, the packet number having the entry number “I” is obtained (step S508), and the corresponding packet is reproduced, so that a back-wind display is performed on the display (step S509). Then, it is judged whether or not a command to stop the fast-rewinding process is inputted (step S510). If it is judged that the command to stop the fast-rewinding process (step S510: Yes), the operational flow escapes from a loop from S507 to S511 and a series of fast-rewinding processes ends. On the other hand, if it is judged that the command to stop the fast-rewinding process is not inputted (step S510: No), the loop from S507 to S511 is repeated with “I” being decremented under a condition I≧0. Finally, if it is judged that the command to stop the fast-rewinding process is inputted (step S510: Yes), the operational flow escapes from the loop from S507 to S511 and a series of the fast-forwarding processes ends. The process after the fast-forwarding/fast-rewinding process varies depending on whether or not the TS object to be reproduced is for the angle reproduction (step S512). If it is judged that it is for the angle reproduction (step S512: Yes), the navi packet is obtained (step S513). On the other hand, if it is judged that it is not for the angle reproduction (step S512: No), the navi packet does not need to be obtained. Incidentally, the navi packet obtaining process at step S513 has already mentioned (FIG. 36).

Thus, the fast-forwarding/fast-rewinding process ends.

(Access Flow in Reproducing)

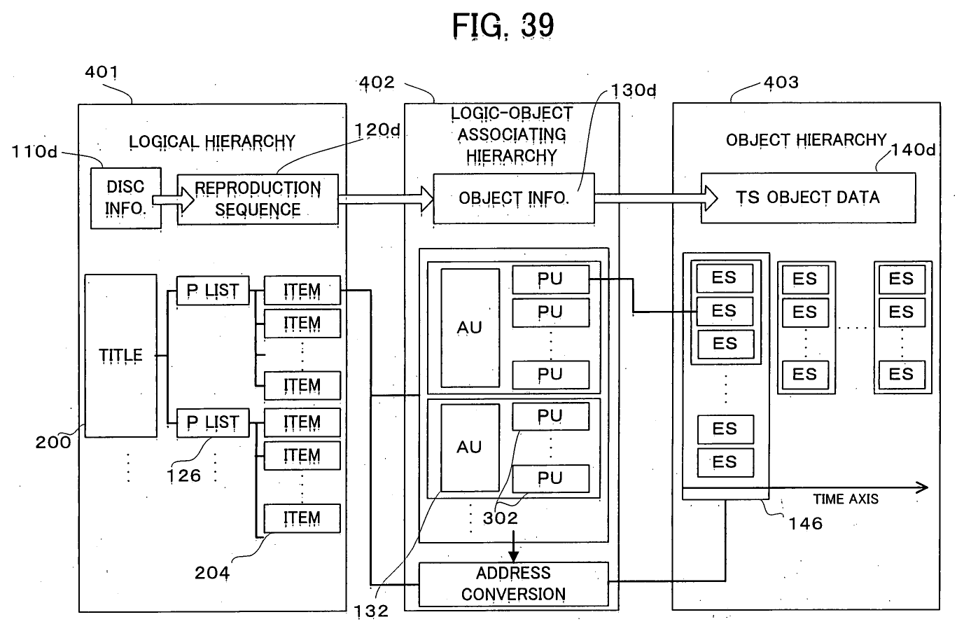

Next, with reference to FIG. 39, the flow of the access in reproducing at the information recording/reproducing apparatus 500, which uses the AU information 132I and the PU information 302I, as one of the features of this embodiment, will be explained as well as the logical structure of the optical disc 100. FIG. 39 is a schematic diagram showing an entire flow of the access in reproducing, in relation to the logical structure of the optical disc 100.

In FIG. 39, the logical structure of the optical disc 100 is categorized broadly into the following three hierarchies: a logical hierarchy 401; an object hierarchy 403; and a logic-object associating hierarchy 402 mutually associating those two hierarchies.

Among them, the logical hierarchy 401 is a hierarchy that logically specifies various logical information to reproduce the desired title when reproducing, as well as the play list to be reproduced and its construction content. In the logical hierarchy 401, disc information 110d indicating the entire titles 200 and the like on the optical disc 100 is written within the disc information file 110 (refer to FIG. 3), and further, reproduction sequence information 120d of the entire contents on the optical disc 100 is written within the play list information file 120 (refer to FIG. 3). More specifically, the construction of one or a plurality of play lists 126 is written in each title 200, as the reproduction sequence information 120d, and the construction of one or a plurality of Items 204 is written in each play list 126. Then, in accessing at the time of the reproduction, the logical hierarchy 401 as described above specifies the title 200 to be reproduced, the play list 126 corresponding to this, and further the Item 204 corresponding to this.

Then, the logic-object associating hierarchy 402 is a hierarchy that specifies the attribute and the physical storing address of the TS object data 140d to be reproduced, so as to specify the combination and/or the construction of the TS object data 140d as being the entity data and perform an address conversion to the object hierarchy 403 from the logical hierarchy 401, on the basis of the information specified in the logical hierarchy 401 as described above. More specifically, in the logic-object associating hierarchy 402, the object information data 130d, which separates a group of the contents constituting each Item 204 into units of the AU 132 and which finely separates each AU 132 into units of the PU 302, is written in the object information file 130 (refer to FIG. 3).

Here, the PU 302 corresponds to an assembly of one or more elementary streams constituting content including the video information, the audio information and the sub-picture information, which relate to an angle from among a plurality of angles switchable to each other through the user operation during the reproduction. The AU 132 is made of an assembly of a plurality of PUs 302 having the switchable angles in the angle reproduction. Therefore, if the AU 132 to be reproduced is identified, and the PU is further identified, the elementary stream to be reproduced is identified. That is, it is possible to reproduce the desired elementary stream from the multi-record on the optical disc 100, without using the PAT and/or PMT shown in FIG. 6. In this manner, in the logic-object associating hierarchy 402, the address conversion to the physical address related to each PU 302 from the logical address related to each Item 204 is executed.

Then, the object hierarchy 403 is a physical hierarchy to reproduce the actual TS object data 140d. In the object hierarchy 403, the TS object data 140d is written within the object data file 140 (refer to FIG. 3). Then, the plurality of TS packets multiplexed at each time point are associated with the PU 302 identified at the logic-object associating hierarchy 402, for each elementary stream.

In this manner, in the object hierarchy 403, the actual object data is reproduced using the physical address obtained by the conversion at the logic-object associating hierarchy 402.

As described above, the three hierarchies shown in FIG. 39 allow the execution of the access with respect to the optical disc 100 in reproducing.

As explained with reference to FIG. 1 to FIG. 39, this embodiment makes it possible to construct the angle without lowering the transfer rate at all or almost at all, by constructing the angle block in the interleaved structure. Furthermore, storing the address information for all the angles into the navi packet makes it possible to perform the angle switching seamlessly or quickly. Especially in the angle block, the navi packet is disposed at the head of each interleaved unit, and the packet next to the navi packet is started from the “I” picture packet in the video stream, and the head flag is introduced into the ES address information, and thereby the appropriate navi packet can be readily retrieved even in the case that the reproduction is required immediately after the fast-forwarding/fast-rewinding process in the angle block. Especially, allowing the PU structure in each AU makes it possible to judge readily a set of elementary stream relating to each other, even in the non-seamless angle switching of the title including the multi-angle.

Additionally, in this embodiment, using the AU and the PU makes it possible to reproduce the TS object 142 even generated on the basis of a different PAT and PMT construction rule, such as a local rule depending on the nation or state, without problems even in the case that the entity of the TS object 142 is stored onto the optical disc 100 as it is, i.e. without the structure of the TS object 142 being changed.

Incidentally, the optical disc 100 as one example of the information recording medium and a recorder or a player related to the optical disc 100 as one example of the information recording/reproducing apparatus are explained in the above described embodiment; however, the present invention is not limited to the optical disc, and the recorder or the player for the optical disc. The present invention is available for the other various information recording/reproducing media corresponding to the high density recording or the high transmission rate, and their recorders or players. Furthermore, although the embodiments of the angle reproduction are explained in the above described embodiments, a “parental reproduction” or the like can be embodied, for reproducing scenes or cuts matched with a parental level defined in advance as for the contents, such as “AO (adults only)” or “R15 (rated 15)”.

According to this embodiment, as described above in detail, it is possible to reproduce surely the navi packet disposed at the head of the interleaved unit without increasing the address information.

The present invention is not limited to the above-described embodiments, and changes may be made if desired without departing from the scope or spirit of the invention which can be read from the claims and the entire specification. An information recording medium, an apparatus for and a method of recording the information, an apparatus for and a method of reproducing the information, an apparatus for and a method of recording and reproducing the information, a computer program for controlling the record or the reproduction, and a data structure including a control signal that accompany such changes are also intended to be within the technical scope of the present invention.

### INDUSTRIAL APPLICABILITY

An information recording medium, a apparatus for and a method of recording the information, an apparatus for and a method of reproducing the information, an apparatus for and a method of recording and reproducing the information, a computer program for controlling the record or the reproduction, and a data structure including a control signal that are associated with the present invention can be applied to a high-density optical disc for consumer or industrial use, such as a DVD, on which various information, such as the video information, the audio information, the sub-picture information, and the reproduction control information, can be recorded at high density and further can be applied to a DVD player, a DVD recorder, and the like. Moreover, they can be applied to an information recording medium, an information recording/reproducing apparatus, or the like, which are inserted in or can be connected to various computer equipment for consumer or industrial use, for example.

1-17. (canceled)

18. An information recording medium on which content information including a plurality of video information is multiplexed-and-recorded, said information recording medium comprising:
an object data file, which is a logically accessible unit, for storing object data which comprises a plurality of packets, each storing therein a piece of the content information;
a reproduction sequence information file for storing reproduction sequence information which defines a reproduction sequence of the object data stored in said object data file; and
an object information file for storing correspondence definition information to control the reproduction of said object data, wherein
said object data is interleaved by a unit of an interleaved unit consisting of a plurality of packets in at least part of a reproduction range,
a navigation packet for storing address information of a next interleaved unit corresponding to each of the plurality of video information is disposed at a head of each of the plurality of interleaved unit, and
the correspondence definition information includes (i) packet indicating information for indicating a packet corresponding to each display start time point and (ii) flag information for indicating whether or not the packet is positioned next to the navigation packet.

19. The information recording medium according to claim 18, wherein if the video information is based on a MPEG (Moving Picture Experts Group phase) standard, the packet corresponding to said each display start time point corresponds to an “I” picture,
the flag information indicates whether or not the packet corresponds to the “I” picture positioned next to the navigation packet.

20. The information recording medium according to claim 18, wherein
the address information of the next interleaved unit is indicated by a packet number starting from a head of an interleaved block consisting of the interleaved units which are interleaved.

21. The information recording medium according to claim 18, wherein the navigation packet further stores unit size information for indicating a size of the next interleaved unit.

22. The information recording medium according to claim 18, wherein the correspondence definition information further has table information for indicating, for each of the plurality of video information, a packet identification number assigned uniquely to a plurality of packets to be multiplexed on a time axis.

23. The information recording medium according to claim 18, wherein
the plurality of video information corresponds to a plurality of an angle video information corresponding to a plurality of view points,
said object data is interleaved so that a reproduction start time point and a reproduction end time point of the interleaved unit as for the plurality of angle video information correspond to each other.

24. The information recording medium according to claim 18, wherein
the navigation packet further stores (i) angle number information for indicating a number of an angle relating to the interleaved unit in which the navigation packet is disposed and (ii) angle quantity information for indicating a quantity of switchable angles.

25. An information recording apparatus for multiplexing and recording content information including a plurality of video information onto an information recording medium,
said information recording apparatus comprising:
a first recording device for recording an object data file, which is a logically accessible unit, for storing object data which comprises a plurality of packets, each storing therein a piece of the content information;
a second recording device for recording a reproduction sequence information file for storing reproduction sequence information which defines a reproduction sequence of the object data stored in said object data file; and
a third recording device for recording an object information file for storing correspondence definition information to control the reproduction of said object data, wherein
said object data is interleaved by a unit of an interleaved unit consisting of a plurality of packets in at least part of a reproduction range,
a navigation packet for storing address information of the next interleaved unit corresponding to each of the plurality of video information is disposed at a head of each of the plurality of interleaved unit, and
the correspondence definition information includes (i) packet indicating information for indicating a packet corresponding to each display start time point and (ii) flag information for indicating whether or not the packet is positioned next to the navigation packet.

26. An information recording method of multiplexing and recording content information including a plurality of video information onto an information recording medium,
said information recording method comprising:
a first recording process of recording an object data file, which is a logically accessible unit, for storing object data which comprises a plurality of packets, each storing therein a piece of the content information;
a second recording process of recording a reproduction sequence information file for storing reproduction sequence information which defines a reproduction sequence of the object data stored in said object data file; and
a third recording process of recording an object information file for storing correspondence definition information to control the reproduction of said object data, wherein
said object data is interleaved by a unit of an interleaved unit consisting of a plurality of packets in at least part of a reproduction range,
a navigation packet for storing address information of the next interleaved unit corresponding to each of the plurality of video information is disposed at a head of each of the plurality of interleaved unit, and
the correspondence definition information includes (i) packet indicating information for indicating a packet corresponding to each display start time point and (ii) flag information for indicating whether or not the packet is positioned next to the navigation packet.

27. An information reproducing apparatus for reproducing recorded content information from an information recording medium on which the content information including a plurality of video information is multiplexed-and-recorded, said information recording medium comprising: an object data file, which is a logically accessible unit, for storing object data which comprises a plurality of packets, each storing therein a piece of the content information; a reproduction sequence information file for storing reproduction sequence information which defines a reproduction sequence of the object data stored in said object data file; and an object information file for storing correspondence definition information to control the reproduction of said object data, wherein said object data is interleaved by a unit of an interleaved unit consisting of a plurality of packets in at least part of a reproduction range, a navigation packet for storing address information of a next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is positioned next to the navigation packet,
said information reproducing apparatus comprising:
a reading device for physically reading information from said information recording medium; and
a reproducing device for reproducing the object data included in the information read by said reading device on the basis of the correspondence definition information and the reproduction sequence information included in the information read by said reading device, and for reproducing the plurality of video information respectively on the basis of the address information stored in the navigation packet included in the information read by said reading device.

28. An information reproducing method of reproducing recorded content information from an information recording medium on which the content information including a plurality of video information is multiplexed-and-recorded, said information recording medium comprising: an object data file, which is a logically accessible unit, for storing object data which comprises a plurality of packets, each storing therein a piece of the content information; a reproduction sequence information file for storing reproduction sequence information which defines a reproduction sequence of the object data stored in said object data file; and an object information file for storing correspondence definition information to control the reproduction of said object data, wherein said object data is interleaved by a unit of an interleaved unit consisting of a plurality of packets in at least part of a reproduction range, a navigation packet for storing address information of a next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is positioned next to the navigation packet,
said information reproducing method comprising:
a reading process of physically reading information from said information recording medium; and
a reproducing process of reproducing the object data included in the information read at said reading process on the basis of the correspondence definition information and the reproduction sequence information included in the information read at said reading process, and of reproducing the plurality of video information respectively on the basis of the address information stored in the navigation packet included in the information read at said reading process.

29. An information recording and reproducing apparatus for recording content information onto an information recording medium on which the content information including a plurality of video information is multiplexed-and-recorded, said information recording medium comprising: an object data file, which is a logically accessible unit, for storing object data which comprises a plurality of packets, each storing therein a piece of the content information; a reproduction sequence information file for storing reproduction sequence information which defines a reproduction sequence of the object data stored in said object data file; and an object information file for storing correspondence definition information to control the reproduction of said object data, wherein said object data is interleaved by a unit of an interleaved unit consisting of a plurality of packets in at least part of a reproduction range, a navigation packet for storing address information of a next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is positioned next to the navigation packet, and for reproducing the recorded content information from said information recording medium,
said information recording and reproducing apparatus comprising:
a first recording device for recording the object data file;
a second recording device for recording the reproduction sequence information file;
a third recording device for recording the object information file;
a reading device for physically reading information from said information recording medium; and
a reproducing device for reproducing the object data included in the information read by said reading device on the basis of the correspondence definition information and the reproduction sequence information included in the information read by said reading device, and for reproducing the plurality of video information respectively on the basis of the address information stored in the navigation packet included in the information read by said reading device.

30. An information recording and reproducing method of recording content information onto an information recording medium on which the content information including a plurality of video information is multiplexed-and-recorded, said information recording medium comprising: an object data file, which is a logically accessible unit, for storing object data which comprises a plurality of packets, each storing therein a piece of the content information; a reproduction sequence information file for storing reproduction sequence information which defines a reproduction sequence of the object data stored in said object data file; and an object information file for storing correspondence definition information to control the reproduction of said object data, wherein said object data is interleaved by a unit of an interleaved unit consisting of a plurality of packets in at least part of a reproduction range, a navigation packet for storing address information of a next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is positioned next to the navigation packet, and of reproducing the recorded content information from said information recording medium,
said information recording and reproducing method comprising:
a first recording process of recording the object data file;
a second recording process of recording the reproduction sequence information file;
a third recording process of recording the object information file;
a reading process of physically reading information from said information recording medium; and
a reproducing process of reproducing the object data included in the information read at said reading process on the basis of the correspondence definition information and the reproduction sequence information included in the information read at said reading process, and of reproducing the plurality of video information respectively on the basis of the address information stored in the navigation packet included in the information read at said reading process.

31. A computer program product for controlling record and for tangibly embodying a program of instructions executable by a computer to make the computer function as at least one portion of a first recording device, a second recording device, and a third recording device,
the computer being provided in an information recording apparatus for multiplexing and recording content information including a plurality of video information onto an information recording medium, said information recording apparatus comprising:
said first recording device for recording an object data file, which is a logically accessible unit, for storing object data which comprises a plurality of packets, each storing therein a piece of the content information;
said second recording device for recording a reproduction sequence information file for storing reproduction sequence information which defines a reproduction sequence of the object data stored in said object data file;
and said third recording device for recording an object information file for storing correspondence definition information to control the reproduction of said object data,
wherein said object data is interleaved by a unit of an interleaved unit consisting of a plurality of packets in at least part of a reproduction range, a navigation packet for storing address information of the next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is positioned next to the navigation packet.

32. A computer program product for controlling reproduction and for tangibly embodying a program of instructions executable by a computer to make the computer function as at least one portion of a reproducing device,
the computer being provided in an information reproducing apparatus for reproducing recorded content information from an information recording medium on which the content information including a plurality of video information is multiplexed-and-recorded, said information recording medium comprising: an object data file, which is a logically accessible unit, for storing object data which comprises a plurality of packets, each storing therein a piece of the content information; a reproduction sequence information file for storing reproduction sequence information which defines a reproduction sequence of the object data stored in said object data file; and an object information file for storing correspondence definition information to control the reproduction of said object data, wherein said object data is interleaved by a unit of an interleaved unit consisting of a plurality of packets in at least part of a reproduction range, a navigation packet for storing address information of a next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is positioned next to the navigation packet,
said information reproducing apparatus comprising:
a reading device for physically reading information from said information recording medium; and
said reproducing device for reproducing the object data included in the information read by said reading device on the basis of the correspondence definition information and the reproduction sequence information included in the information read by said reading device, and for reproducing the plurality of video information respectively on the basis of the address information stored in the navigation packet included in the information read by said reading device.

33. A computer program product for controlling record and reproduction and for tangibly embodying a program of instructions executable by a computer to make the computer function as at least one portion of a first recording device, a second recording device, a third recording device, and a reproducing device,
the computer being provided in an information recording and reproducing apparatus for recording content information onto an information recording medium on which the content information including a plurality of video information is multiplexed-and-recorded, said information recording medium comprising: an object data file, which is a logically accessible unit, for storing object data which comprises a plurality of packets, each storing therein a piece of the content information; a reproduction sequence information file for storing reproduction sequence information which defines a reproduction sequence of the object data stored in said object data file; and an object information file for storing correspondence definition information to control the reproduction of said object data, wherein said object data is interleaved by a unit of an interleaved unit consisting of a plurality of packets in at least part of a reproduction range, a navigation packet for storing address information of a next interleaved unit corresponding to each of the plurality of video information is disposed at a head of each of the plurality of interleaved unit, and the correspondence definition information includes (i) packet indicating information for indicating a packet corresponding to each display start time point and (ii) flag information for indicating whether or not the packet is positioned next to the navigation packet, and for reproducing the recorded content information from said information recording medium,
said information recording and reproducing apparatus comprising:
said first recording device for recording the object data file;
said second recording device for recording the reproduction sequence information file;
said third recording device for recording the object information file;
a reading device for physically reading information from said information recording medium; and
said reproducing device for reproducing the object data included in the information read by said reading device on the basis of the correspondence definition information and the reproduction sequence information included in the information read by said reading device, and for reproducing the plurality of video information respectively on the basis of the address information stored in the navigation packet included in the information read by said reading device.

34. A data structure including a control signal, in which content information including a plurality of video information is multiplexed-and-recorded, having:
an object data file, which is a logically accessible unit, for storing object data which comprises a plurality of packets, each storing therein a piece of the content information;
a reproduction sequence information file for storing reproduction sequence information which defines a reproduction sequence of the object data stored in said object data file; and
an object information file for storing correspondence definition information to control the reproduction of said object data, wherein
said object data is interleaved by a unit of an interleaved unit consisting of a plurality of packets in at least part of a reproduction range,
a navigation packet for storing address information of the next interleaved unit corresponding to each of the plurality of video information is disposed at a head of each of the plurality of interleaved unit, and
the correspondence definition information includes (i) packet indicating information for indicating a packet corresponding to each display start time point and (ii) flag information for indicating whether or not the packet is the packet positioned next to the navigation packet.
